(19) United States
(12) Patent Application Publication
(10) Pub. No.: US 2013/0162722 A1
(43) Pub. Date: Jun. 27, 2013

(54) INKJET PRINTING METHOD AND SYSTEM

(71) Applicants: Thomas B. Brust, Webster, NY (US); Catherine A. Falkner, Rochester, NY (US); Kurt Michael Schroeder, Spencerport, NY (US); Yongcai Wang, Rochester, NY (US); Brian J. Antalek, Livonia, NY (US); James R. Hauenstein, Williamson, NY (US); Thomas Henry Mourey, Rochester, NY (US); James M. Hewitt, Fairport, NY (US)

(72) Inventors: Thomas B. Brust, Webster, NY (US); Catherine A. Falkner, Rochester, NY (US); Kurt Michael Schroeder, Spencerport, NY (US); Yongcai Wang, Rochester, NY (US); Brian J. Antalek, Livonia, NY (US); James R. Hauenstein, Williamson, NY (US); Thomas Henry Mourey, Rochester, NY (US); James M. Hewitt, Fairport, NY (US)

(21) Appl. No.: 13/334,130

(22) Filed: Dec. 22, 2011

(51) Int. Cl. B41J 2/04

(52) U.S. Cl. 347/54

(57) ABSTRACT

Pigment-based ink composition, and inkjet printing systems and methods employing such ink composition. The ink contains an aqueous polyurethane additive including polyurethane polymer chains including at least first segments having a polysiloxane group of Mw greater than about 10,000 pendant to the polyurethane polymer chain backbone, wherein (i) the polyurethane additive further comprises polyurethane polymer chains including second segments having a polysiloxane group of Mw less than about 6,000 either pendant to the polyurethane polymer backbone or a part of the polyurethane polymer backbone or (ii) the composition further comprises a polysiloxane polymer additive of Mw of less than about 6,000 which is not pendant to a polyurethane polymer backbone or a part of a polyurethane polymer backbone. The polyurethane additive has a Mw of at least 10,000 and a sufficient number of acid groups to provide an acid number greater than 20.

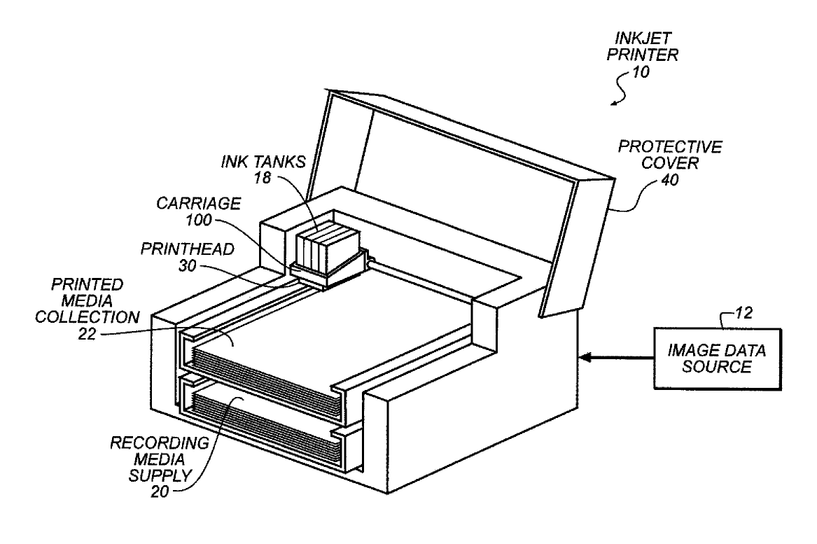

### CROSS-REFERENCE TO RELATED APPLICATIONS

Reference is made to commonly assigned U.S. Ser. No. ______ (Kodak Docket K000683), directed towards “Inkjet Ink Composition,” and U.S. Ser. No. ______ (Kodak Docket K000790), directed towards “Polymer Composition”, both filed concurrently herewith, the disclosures of which are incorporated by reference herein in their entireties.

### FIELD OF THE INVENTION

The invention relates generally to the field of pigmented inks for ink jet printing, and in particular to inks which are useful for drop-on-demand ink jet printing. More specifically, the invention relates to pigmented inks for high-speed thermal inkjet printing which jet reliably and result in durable images, and to siloxane group functionalized polyurethane polymer compositions employed in such inks.

### BACKGROUND OF THE INVENTION

Ink jet printing is a non-impact method for producing printed images by the deposition of ink droplets in a pixel-by-pixel manner to an image-recording element in response to digital signals. There are various methods that may be utilized to control the deposition of ink droplets on the image-recording element to yield the desired printed image. In one process, known as drop-on-demand ink jet, individual droplets are projected as needed onto the image-recording element to form the desired printed image. Common methods of controlling the ejection of ink droplets in drop-on-demand printing include thermal bubble formation (thermal ink jet (TIJ)) and piezoelectric transducers. In another process known as continuous ink jet (CIJ), a continuous stream of droplets is generated and expelled in an image-wise manner onto the surface of the image-recording element, while non-imaged droplets are deflected, caught and recycled to an ink sump. Ink jet printers have found broad applications across markets ranging from desktop document and photographic-quality imaging, to short run printing and industrial labeling.

Ink compositions containing colorants used in ink jet printers can be classified as either pigment-based, in which the colorant exists as pigment particles suspended in the ink composition, or as dye-based, in which the colorant exists as a fully solvated dye species that consists of one or more dye molecules. Pigments are highly desirable since they are far more resistant to fading than dyes. However, pigment-based inks have a number of drawbacks. Great lengths must be undertaken to reduce a pigment particle to a sufficiently small particle size and to provide sufficient colloidal stability to the particles. Pigment-based inks often require a lengthy milling operation to produce particles in the sub-micron range needed for most modern ink applications. If the pigment particles are too large, light scattering can have a detrimental effect on optical density and gloss in the printed image.

A second drawback of pigmented inks is their durability after printing, especially under conditions where abrasive forces have been applied to the printed image. Pigment-based inks typically reside at the surface of the imaging receiver to which they are printed and this makes the printed images particularly susceptible to abrasive forces. To this extent, pigmented inks have been formulated with various polymer binders, dispersants and other addenda to provide durable images that can withstand post printing physical abuse and environmental conditions.

The degree of abrasion resistance of a printed image is also a function of time after printing. At short time intervals after printing, typically from a few minutes to a few hours, the ink undergoes several complex dynamic changes. As the ink contacts the receiver, some of the components penetrate into the receiver and the droplets can simultaneously spread laterally on the receiver surface. Carrier fluids such as water and humectants are drawn into the receiver by capillary forces and the polymer binders begin to film form. At short time intervals the binder film formation is incomplete and the resulting pigment cake is particularly susceptible to abrasive forces. In some cases, the incomplete polymer binder film formation results in a tacky surface that can stick to surfaces within the printer that transport the printed image. Typically, the more total fluid that is printed to the receiver (and hence more water) the longer it takes for the ink to dry and form a durable image.

The abrasion resistance of the image is further affected by the presence of humectants, which are necessary for optimal firing performance, but which are retained in the pigment cake for some period of time. Since most humectants have much lower vapor pressures than water, they are relatively slow to evaporate and can be retained in the image receiver for several hours. Humectants can have the effect of plasticizing the polymer binder and making the surface of the image tacky or softer than if no humectant was present. Once the humectants evaporate, the resulting pigment cake, consisting primarily of pigment and binders, reaches a steady state composition and determines the long-term abrasion resistance of the printed image.

Images printed from an ink jet printer are also susceptible to abrasive forces as the image receiver is advanced through the printer. Typically, there is some mechanical means, such as a series of transport rollers, for advancing the print past the printhead and out of the printer. In some printer designs a spur wheel is used to advance the printed receiver. Spur wheels are often made from a hard plastic or metal and have the shape of a disk with points or spurs located on the periphery of the wheel. The spurs contact the printed receiver and can physically penetrate the uppermost area of the printed image leaving behind a small hole. In extreme cases the spurs can plow into the receiver and tear off small sections of the imaged areas. In either case, the mechanical abrasion caused by the spur wheel occurs at short time intervals on the order of a few seconds after printing and results in a defect that is objectionable to the eye.

Pigmented inks for ink jet printing have been formulated with acrylic polymers, however, the acrylic polymers alone are insufficient in providing durable images that resist scratches and other forms of physical abuse. A second class of polymers that have been used as abrasion resistance additives in pigment-based inks are the polyurethanes, or urethane resins as they are sometimes called. U.S. Pat. No. 6,136,890 discloses a pigment-based ink jet ink wherein the pigment particles are stabilized by a polyurethane dispersant. U.S. Patent Application Pub. No. 2004/0242726 discloses a pigment dispersed by a cross-linking step between a resin having a urethane bond and a second water-soluble polymer. U.S. Patent Application Pub. Nos. 2008/0207820 and 2008/0207811 disclose pigment based inks comprising dispersed polyurethane additive of specified compositions and weight percentages and water soluble acrylic polymer.

Although polyurethanes are known for their excellent abrasion resistance, they also have a number of drawbacks. For example, not all polyurethane polymers are conducive to jetting from a thermal ink jet head. In particular, water-dispersible polyurethane particles, such as those disclosed in U.S. Pat. Nos. 6,533,408, 6,268,101, Statutory Invention Registration No. U.S. H2113H, and published U.S. patent applications 2004/0130608 and 2004/0229976 are particularly difficult to jet from a thermal inkjet printhead at high firing frequencies. It is highly desirable to fire inks at high firing frequencies from an inkjet printer since this is one variable that controls the speed at which the image can be printed.

Another way to improve the abrasion resistance of a printed image is to apply a clear ink as an overcoat to the image. The clear inks, also known as colorless ink compositions, are typically formulated with polymer, water, and other components commonly used in aqueous-based ink jet ink formulations, for example, humectants, organic solvents, surfactants and biocides. United States Patent Publication numbers 2006/0100306 and 2006/0100308 disclose the use of polyurethanes and mixtures of polyurethanes and acrylic polymers having specified acid numbers for use in clear ink compositions. However, clear inks formulated with polyurethanes also suffer from the same short term durability issues as colored inks since they have many components in common with their colored ink counterparts. In addition, the application of a clear ink increases the total amount of water applied to the receiver and therefore slows down the drying of the imaged area of the prints. Although the application of clear ink can improve the long term durability, its application can adversely affect the short term durability due to the increased water load on the receiver.

Both pigment and clear inks can be difficult to jet through ink jet print heads having small nozzle diameters especially by the thermal ink jet printing process. In recent years, thermal ink jet printers have moved to higher jetting frequencies and smaller nozzle diameters to provide faster printing speeds with higher image quality. Thermal ink jet printers are now capable of printing (in drop volumes of 3 picoliters or less) at jetting frequencies in excess of 10 kHz and the need for higher frequency firing is a highly desirable feature. However, this high frequency firing often comes at the cost of variability in the firing velocity, which leads to poor image quality in the final printed image. In addition, the demands of current thermal ink jet printing require that the nozzles fire for a large number of firings during the life-time of a printer. As an example, a typical ink jet nozzle may be required to fire in excess of 5×10⁷, and up to as many as 1×10⁹, individual firing events without malfunctioning or ceasing to fire altogether. U.S. Patent Application Pub. No. 2010/0055322 discloses the use of a polyurethane additive having at least a first soft segment having siloxane groups in pigmented inks to provide an improved combination of scratch resistance and jettability.

Another problem for drop-on-demand inkjet printing devices, especially those using pigment inks, is the recovery of a nozzle that has not been fired for a period of time such that the ink in the chamber has begun to dry out. This can occur during the time required to print a document if only certain inks are required for that document and the remaining inks remain idle. Most ink jet printers will fire idle nozzles at specified intervals to maintain the reliable firing of all the jets. Unfortunately, pigment inks, and in particular pigment inks with high loads of pigment and polymers designed for high image quality and durability on the broadest range of media, can still show poor reliability even with reasonable idle-jet maintenance routines. If an ink requires excessive amounts of maintenance firing, this can also reduce the number of pages that can be printed from an ink tank, thereby reducing the efficiency of the tank and increasing the cost of printing.

The preparation of the inks, especially in large scale manufacturing, requires that the individual ink components be stable during storage and easy to handle in large vessels sometimes with poor stirring. While most components are pure compounds or homogenous solutions, pigment dispersions can settle or undergo particle growth, and some polymer solutions may also exist as a dispersion of hydrophobic and hydrophilic phases. These dispersions may not be stable over long periods of storage and may separate into distinct layers of material that cannot be easily mixed and redispersed. This causes difficulty in a manufacturing environment because these unstable components would require an extra mixing step to redisperse the polymer phases if possible, or cause variability in the composition of the ink.

Pigment-based inks with a high loading of pigments are further desirable to provide high image quality on the widest range of print media. To also ensure that these high pigment loaded inks have abrasion durability, a higher loading of binder polymer is typically also required. Inks with high loads of pigment and especially higher Mw polymers often used as binders, however, may result in poor jetting reliability, especially when jets remain idle for even a few seconds. These high-solids inks must still be capable of reliable high-speed jetting and the components must have adequate long-term stability to enable efficient large-scale manufacturing.

### SUMMARY OF THE INVENTION

It has been found that polyurethanes prepared with relatively large, extremely hydrophobic soft segments such as polysiloxane units having molecular weights of greater than about 10,000 daltons, while advantageously employed in pigmented inks for providing durability of a printed image, can exhibit dispersion instability when allowed to stand without agitation for long periods of time. It is therefore an object of the invention to provide pigment-based inks for inkjet printing which contain an aqueous polyurethane binder that imparts both long-term storage stability and excellent short and long term abrasion resistance at low enough polymer levels to ensure reliable high speed jetting with efficient print head maintenance routines.

In one embodiment, the invention is directed towards an inkjet ink composition comprising;

(a) water,

(b) dispersed pigment particles,

(c) a humectant, and

(d) a polyurethane polymer additive comprising polyurethane polymer chains including at least first segments having a polysiloxane group of weight average molecular weight greater than about 10,000 daltons pendant to the polyurethane polymer chain backbone,
wherein (i) the polyurethane polymer additive further comprises polyurethane polymer chains including second segments having a polysiloxane group of weight average molecular weight less than about 6,000 daltons either pendant to the polyurethane polymer backbone or a part of the polyurethane polymer backbone or (ii) the composition further comprises a polysiloxane polymer additive of weight average molecular weight of less than about 6,000 daltons which is not pendant to a polyurethane polymer backbone or a part of a polyurethane polymer backbone, and
further wherein the polyurethane polymer additive has a weight average molecular weight of at least 10,000 daltons and a sufficient number of acid groups to provide an acid number greater than 20.

The invention also includes an ink set including at least one such inkjet ink composition, an inkjet printing system comprising an inkjet printer responsive to digital signals and containing such an inkjet ink composition, and an inkjet printing method comprising jetting such an inkjet ink in the form of ink droplets onto a recording element to form a printed image, and further includes siloxane group functionalized polyurethane polymer compositions employed in such inks, systems, and methods. Use of an aqueous polyurethane binder additive that is prepared with a combination of such relatively high Mw and low Mw siloxane segments, or alternatively a polyurethane binder additive prepared with such relatively high Mw siloxane segments in combination with a distinct relatively low Mw polysiloxane polymer additive, has been found to advantageously impart both long-term storage stability and excellent short and long term abrasion resistance at low enough polymer levels to ensure reliable high speed jetting with efficient print head maintenance routines.

### BRIEF DESCRIPTION OF THE DRAWINGS

The FIGURE is a schematic view of an inkjet printer useful in the invention.

### DETAILED DESCRIPTION OF THE INVENTION

The invention is summarized above. Inkjet printing systems useful in the invention comprise a printer, at least one ink, and an image recording element, typically a sheet, (herein also “media”), suitable for receiving ink from an inkjet printer. The method of the invention employs the inkjet printer of the invention to provide an image on media. Inkjet printing is a non-impact method for producing printed images by the deposition of ink droplets in a pixel-by-pixel manner to an image-recording element in response to digital data signals. There are various methods that may be utilized to control the deposition of ink droplets on the image-recording element to yield the desired printed image. In one process, known as drop-on-demand inkjet, individual ink droplets are projected as needed onto the image-recording element to form the desired printed image. Common methods of controlling the projection of ink droplets in drop-on-demand printing include piezoelectric transducers, thermal bubble formation or an actuator that is made to move.

Drop-on-demand (DOD) liquid emission devices have been known as ink printing devices in ink jet printing systems for many years. Early devices were based on piezoelectric actuators such as are disclosed by Kyser et al., in U.S. Pat. No. 3,946,398 and Stemme in U.S. Pat. No. 3,747,120. A currently popular form of ink jet printing, thermal ink jet (or “thermal bubble jet”), uses electrically resistive heaters to generate vapor bubbles which cause drop emission, as is discussed by Hara, et al., in U.S. Pat. No. 4,296,421. In another process, known as continuous inkjet, a continuous stream of droplets is generated, a portion of which are deflected in an image-wise manner onto the surface of the image-recording element, while un-imaged droplets are caught and returned to an ink sump. Continuous inkjet printers are disclosed in U.S. Pat. Nos. 6,588,888, 6,554,410, 6,682,182, 6,793,328, 6,866,370, 6,575,566, and 6,517,197.

The FIGURE shows one schematic example of an inkjet printer 10 that includes a protective cover 40 for the internal components of the printer. The printer contains a recording media supply 20 in a tray. The printer includes one or more ink tanks 18 (shown here as having four inks) that supply ink to a printhead 30. The printhead 30 and ink tanks 18 are mounted on a carriage 100. The printer includes a source of image data 12 that provides signals that are interpreted by a controller (not shown) as being commands to eject drops of ink from the printhead 30. Printheads may be integral with the ink tanks or separate. Exemplary printheads are described in U.S. Pat. No. 7,350,902. In a typical printing operation a media sheet travels from the recording media supply 20 in a media supply tray to a region where the printhead 30 deposits droplets of ink onto the media sheet. The printed media collection 22 is accumulated in an output tray.

The ink jet inks of the present invention are aqueous-based inks. By aqueous-based it is meant that the ink comprises mainly water as the carrier medium for the remaining ink components. In a preferred embodiment, the inks of the present invention comprise at least about 50 weight percent water. Pigment-based inks are defined as inks containing at least a dispersion of water-insoluble pigment particles. A clear ink is defined as an ink composition that does not contain colorants, including colored pigments or colored dyes. The clear ink is typically aqueous based and can contain humectants and polymers used in the art of inkjet printing. The clear ink can be slightly colored due to the presence of humectants, polymers or impurities, but is not intentionally colored by the addition of a colorant.

An ink-set is defined as a set of two or more inks. An ink set may contain pigment-based inks of different colors, for example, cyan, magenta, yellow, red, green, blue, orange, violet or black. In one embodiment, a carbon black pigmented ink is used in an ink set comprising at least three inks having separately, a cyan, a magenta and a yellow colorant. Useful ink sets may also include, in addition to the cyan, magenta and yellow inks, complimentary colorants such as red, blue, violet, orange or green inks. In addition, the ink set may comprise light and dark colored inks, for example, light cyan and light magenta inks commonly used in the ink sets of wide format printers. It is possible to include one or more inks that comprise a mixture of different colored pigments in the ink set. An example of this is a carbon black pigment mixed with one or more colored pigments or a combination of different colored pigments. An ink-set may also include one or more pigment-based inks in combination with one or more clear inks. An ink-set may also include at least one or more pigment-based inks in combination with additional inks that are dye-based ink. An ink set may further comprise one or more inks containing a self-dispersing carbon black pigment ink which is used primarily for printing of text and a plurality of cyan, magenta, yellow and black inks which are used primarily for photographic quality printing.

The pigment-based inks of the present invention comprise pigment particles dispersed in the aqueous carrier. The pigment particles are stabilized in the aqueous carrier with a dispersant or are self-dispersed without the need for a dispersant. The pigment particles that are useful in the invention may be prepared by any method known in the art of ink jet printing. Useful methods commonly involve two steps: (a) a dispersing or milling step to break up the pigments to primary particles, where primary particle is defined as the smallest identifiable subdivision in a particulate system, and (b) a dilution step in which the pigment dispersion from step (a) is diluted with the remaining ink components to give a working strength ink.

The milling step (a) is carried out using any type of grinding mill such as a media mill, a ball mill, a two-roll mill, a three-roll mill, a bead mill, and air-jet mill, an attritor, or a liquid interaction chamber. In the milling step (a), pigments are optionally suspended in a medium that is typically the same as or similar to the medium used to dilute the pigment dispersion in step (b). Inert milling media are optionally present in the milling step (a) in order to facilitate breakup of the pigments to primary particles. Inert milling media include such materials as polymeric beads, glasses, ceramics, metals and plastics as described, for example, in U.S. Pat. No. 5,891,231. Milling media are removed from either the pigment dispersion obtained in step (a) or from the ink composition obtained in step (b).

The dispersant for the pigment particles can be a surfactant and can be added during the milling step (a) in order to facilitate breakup of the pigments into primary particles, or dilution step (b) to maintain particle stability and prevent settling. Surfactants suitable for use as dispersants for the pigment particles in the invention include, but are not limited to, those commonly used in the art of ink jet printing. For aqueous pigment-based ink compositions, useful surfactants include anionic, cationic or nonionic surfactants such as sodium dodecylsulfate, sodium dioctyl sulfosuccinate, or potassium or sodium oleylmethyltaurate as described in, for example, U.S. Pat. No. 5,679,138, U.S. Pat. No. 5,651,813 or U.S. Pat. No. 5,985,017.

The dispersant for the pigment particles can also be a polymeric dispersant, and pigment particles which are colloidally stabilized by a polymeric dispersant are referred to as a polymer dispersed pigment dispersion. Polymeric dispersants may be added to the pigment dispersion prior to, or during the milling step (a), and include polymers such as homopolymers and copolymers; anionic, cationic or nonionic polymers; or random, block, branched or graft polymers. Polymeric dispersants useful in the milling operation include random and block copolymers having hydrophilic and hydrophobic portions; see for example, U.S. Pat. No. 4,597,794; U.S. Pat. No. 5,085,698; U.S. Pat. No. 5,519,085; U.S. Pat. Nos. 5,272,201; 5,172,133; U.S. Pat. No. 6,043,297 and WO 2004/111140A1; and graft copolymers; see for example, U.S. Pat. No. 5,231,131; U.S. Pat. No. 6,087,416; U.S. Pat. No. 5,719,204; or U.S. Pat. No. 5,714,538. Among these polymeric dispersants, anionic polymeric dispersants are especially useful.

Typically, these polymeric dispersants are copolymers made from hydrophobic and hydrophilic monomers. In this case, the copolymers are designed to act as dispersants for the pigment by virtue of the arrangement and proportions of hydrophobic and hydrophilic monomers. The polymeric dispersant (copolymer) for the pigment is not limited in the arrangement of the monomers comprising the copolymer. The arrangement of monomers may be totally random, or they may be arranged in blocks such as AB or ABA wherein, A is the hydrophobic monomer and B is the hydrophilic monomer. In addition, the polymer make take the form of a random terpolymer or an ABC tri-block wherein, at least one of the A, B and C blocks is chosen to be the hydrophilic monomer and the remaining blocks are hydrophobic blocks dissimilar from one another.

Polymeric dispersants useful for dispersing the pigment particles can be selected from acrylics and styrene-acrylics. Styrene-acrylic polymeric dispersants especially useful in the present invention are copolymers of styrenic monomers and carboxylate monomers. Examples of such dispersants include copolymers of styrene and/or alphamethyl styrene and acrylic acid and/or methacrylic acid (such as the JONCRYL® BASF or TRUDOT® Mead Westvaco polymers) or styrene maleic anhydride and styrene maleic anhydride amic acid copolymers (such as SMA-1440, SMA-17352, SMA-1000, SMA-2000® Sartomer Inc.).

Acrylic polymeric dispersants useful in the present invention are typically formed from one or more acrylic monomer and one or more ionizable monomer, such as, for example carboxylated or sulfonated monomers. Acrylic polymeric dispersants are typically formed from one or more hydrophobic acrylate monomer including, for example, methylmethacrylate, ethylmethacrylate, butylmethacrylate, hexylmethacryate, octylmethacrylate and decylmethacrylate.

Other especially useful polymeric dispersants are those where the hydrophobic monomer is selected from benzyl methacrylate or acrylate, or from acrylic acid esters containing an aliphatic chain having twelve or more carbons and where the hydrophilic monomer is a carboxylated monomer. Examples of acrylic acid esters having twelve or more carbons include; lauryl acrylate, lauryl methacrylate, tridecyl acrylate, tridecyl methacrylate, tetradecyl acrylate, tetradecyl methacrylate, cetyl acrylate, iso-cetyl acrylate, stearyl methacrylate, iso-stearyl methacrylate, stearyl acrylate, stearyl methacrylate, decyltetradecyl acrylate, decyltetradecyl methacrylate. Preferably the methacrylate or acrylate monomer is stearyl or lauryl methacrylate or acrylate. The hydrophobic portion of the polymer may be prepared from one or more of the hydrophobic monomers. Desirable carboxylated hydrophilic monomers are acrylic acid or methacrylic acid, or combinations thereof.

Typically, the weight average molecular weight of the polymeric dispersant has an upper limit such that it is less than 50,000 daltons. Desirably the weight average molecular weight of the copolymer is less than 25,000 daltons; more desirably it is less than 15,000 and most desirably less than 10,000 daltons. The copolymer dispersants preferably have a weight average molecular weight lower limit of greater than 500 daltons.

In one embodiment, copolymer dispersants are employed which comprise a hydrophobic monomer having a carbon chain length of greater than or equal to 12 carbons present in an amount of at least 10% by weight of the total copolymer, and more desirably greater than 20% by weight, an optional additional hydrophobic monomer comprising an aromatic group and a hydrophilic monomer that is methacrylic acid. For example, the additional aromatic group containing monomer may be benzyl acrylate or benzyl methacrylate. An especially useful additional monomer is benzyl methacrylate.

The total amount of hydrophobic monomers, comprising the monomer having a chain with greater than or equal to 12 carbons and optionally, monomer containing an aromatic group, may be present in the polymer in an amount of 20 to 95% by weight of the total polymer. The hydrophobic aromatic-group containing monomer may be present in an amount from about 0 to 85% by weight of the total polymer, more typically from about 0 to 60%, and desirably from about 0 to 50%. A particularly useful embodiment of a polymeric dispersant for the pigment particles is a terpolymer of benzyl methacrylate, stearyl methacrylate and methacrylic acid. Particularly useful polymeric pigment dispersants are further described in United States Patent Application Pub. Nos. 2006/0012654 and 2007/0043144.

Encapsulating type polymeric dispersants and polymeric dispersed pigments thereof can also be used in the invention. Specific examples are described in U.S. Pat. Nos. 6,723,785, 6,852,777, and United States Patent Application Pub. Nos. 2004/0132942, 2005/0020731, 2005/00951, 2005/0075416, 2005/0124726, 2004/007749, and 2005/0124728. Encapsulating type polymeric dispersants can be especially useful because of their high dispersion stability on keeping and low degree of interaction with ink components. Composite colorant particles having a colorant phase and a polymer phase are also useful in aqueous pigment-based inks of the invention. Composite colorant particles are formed by polymerizing monomers in the presence of pigments; see for example, United States Patent Application Pub. Nos. 2003/0199614, 2003/0203988, or 2004/0127639. Microencapsulated-type pigment particles are also useful and consist of pigment particles coated with a resin film; see for example U.S. Pat. No. 6,074,467.

The pigment dispersions useful in pigment-based ink compositions of the present invention desirably have a volume weighted median particle diameter of less than 200 nm and more desirably less than 100 nm. The volume-weighted particle size distribution may be measured by a dynamic light scattering method, such as by using a HORIBA LA-920 nanoparticle analyzer and/or MICROTRAC ultrafine particle analyzer (UPA) Model 150 from Leeds & Northrop. The analysis provides percentile data that show the percentage of the volume of the particles that is smaller than an indicated size. The 50 percentile is known as the median diameter, which is also referred to herein as median particle size. In a particularly useful embodiment, 90 percent of the weight of the pigment particles in the distribution have a diameter less than 100 nm, and desirably less than 80 nm.

Self-dispersing pigments useful for the practice of the invention are those that have been subjected to a surface treatment such as oxidation/reduction, acid/base treatment, or functionalization through coupling chemistry. The surface treatment can render the surface of the pigment with anionic, cationic or non-ionic groups. Examples of self-dispersing type pigments include, but are not limited to, Cab-O-Jet® 200 and Cab-O-Jet® 300 (Cabot Corp.), Bonjet® Black CW-1, CW-2, and CW-3 (Orient Chemical Industries, Ltd.) and Aqua Black® 162 and 001 (Tokai Carbon, Ltd.).

Pigments suitable for use in the invention include, but are not limited to, azo pigments, monoazo pigments, disazo pigments, azo pigment lakes, β-Naphthol pigments, Naphthol AS pigments, benzimidazolone pigments, disazo condensation pigments, metal complex pigments, isoindolinone and isoindoline pigments, polycyclic pigments, phthalocyanine pigments, quinacridone pigments, perylene and perinone pigments, thioindigo pigments, anthrapyrimidone pigments, flavanthrone pigments, anthanthrone pigments, dioxazine pigments, triarylcarbonium pigments, quinophthalone pigments, diketopyrrolo pyrrole pigments, titanium oxide, iron oxide, and carbon black. Metal or metal oxide particles, or carbon structures such as nanotubes or “buckyballs” may be employed included in inks of the invention as pigments, or as electrically conductive additives for printing conductive patterns.

Typical examples of pigments that may be used include Color Index (C. I.) Pigment Yellow 1, 2, 3, 5, 6, 10, 12, 13, 14, 16, 17, 62, 65, 73, 74, 75, 81, 83, 87, 90, 93, 94, 95, 97, 98, 99, 100, 101, 104, 106, 108, 109, 110, 111, 113, 114, 116, 117, 120, 121, 123, 124, 126, 127, 128, 129, 130, 133, 136, 138, 139, 147, 148, 150, 151, 152, 153, 154, 155, 165, 166, 167, 168, 169, 170, 171, 172, 173, 174, 175, 176, 177, 179, 180, 181, 182, 183, 184, 185, 187, 188, 190, 191, 192, 193, 194; C. I. Pigment Red 1, 2, 3, 4, 5, 6, 7, 8, 9, 10, 11, 12, 13, 14, 15, 16, 17, 18, 21, 22, 23, 31, 32, 38, 48:1, 48:2, 48:3, 48:4, 49:1, 49:2, 49:3, 50:1, 51, 52:1, 52:2, 53:1, 57:1, 60:1, 63:1, 66, 67, 68, 81, 95, 112, 114, 119, 122, 136, 144, 146, 147, 148, 149, 150, 151, 164, 166, 168, 169, 170, 171, 172, 175, 176, 177, 178, 179, 181, 184, 185, 187, 188, 190, 192, 194, 200, 202, 204, 206, 207, 210, 211, 212, 213, 214, 216, 220, 222, 237, 238, 239, 240, 242, 243, 245, 247, 248, 251, 252, 253, 254, 255, 256, 258, 261, 264; C.I. Pigment Blue 1, 2, 9, 10, 14, 15:1, 15:2, 15:3, 15:4, 15:6, 15, 16, 18, 19, 24:1, 25, 56, 60, 61, 62, 63, 64, 66, bridged aluminum phthalocyanine pigments; C.I. Pigment Black 1, 7, 20, 31, 32; C. I. Pigment Orange 1, 2, 5, 6, 13, 15, 16, 17, 17:1, 19, 22, 24, 31, 34, 36, 38, 40, 43, 44, 46, 48, 49, 51, 59, 60, 61, 62, 64, 65, 66, 67, 68, 69; C.I. Pigment Green 1, 2, 4, 7, 8, 10, 36, 45; C.I. Pigment Violet 1, 2, 3, 5:1, 13, 19, 23, 25, 27, 29, 31, 32, 37, 39, 42, 44, 50; or C.I. Pigment Brawn 1, 5, 22, 23, 25, 38, 41, 42.

Ink compositions useful in the invention also comprise a humectant in order to achieve reliable firing at high frequency with low velocity variability. Representative examples of humectants which may be employed in the present invention include; (1) triols, such as; glycerol, 1,2,6-hexanetriol, 2-ethyl-2-hydroxymethyl-propane diol, trimethylolpropane, alkoxlated triols, alkoxylated pentaerythritols, saccharides and sugar alcohols, (2) diols, such as ethylene glycol, diethylene glycol, triethylene glycol, propylene glycol, polyalkylene glycols having four or more alkylene oxide groups, 1,3-propane diol, 1,2-butane diol, 1,3-butane diol, 1,4-butane diol, 1,2-pentane diol, 1,5-pentanediol, 1,2-hexanediol, 1,6-hexane diol, 2-methyl-2,4-pentanediol, 1,2-heptane diol, 1,7-hexane diol, 2-ethyl-1,3-hexane diol, 1,2-octane diol, 2,2,4-trimethyl-1,3-pentane diol, 1,8-octane diol; and thioglycol, or a mixture thereof.

Desirable humectants are polyhydric alcohols having three or more hydroxyl groups. A particularly useful humectant is glycerol. Typical aqueous-based ink compositions useful in the invention may contain 1-30% weight percent humectant(s), especially from 2-20% humectant, most desirably from 2-15% humectant. Inks comprising humectants having the aforementioned viscosity and concentration ranges are ideal for maintaining ink viscosities in an acceptable range for high speed firing from a thermal ink jet printhead with low variability in firing velocity.

The ink compositions of the present invention may also include, in addition to the humectant, a water miscible co-solvent or penetrant. Representative examples of co-solvents used in the aqueous-based ink compositions include (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofinfuryl alcohol; (2) lower mono- and di-alkyl ethers derived from the polyhydric alcohols; such as, ethylene glycol monomethyl ether, ethylene glycol monobutyl ether, ethylene glycol monoethyl ether acetate, diethylene glycol monomethyl ether, and diethylene glycol monobutyl ether acetate (3) nitrogen-containing compounds such as urea, 2-pyrrolidinone, 1-(2-hydroxyethyl)-2-pyrrolidinone, N-methyl-2-pyrrolidinone, 2-imidazolidone, and 1,3-dimethyl-2-imidazolidinone; and (4) sulfur-containing compounds such as 2,2′-thiodiethanol, dimethyl sulfoxide, tetramethylene sulfone, and sulfolane. Typical aqueous-based ink compositions useful in the invention may contain 0-20 weight percent co-solvent(s).

Ink compositions of the present invention comprise at least one water-dispersible polyurethane compound. By water-dispersible it is meant to include individual polymer molecules or colloidal assemblies of polymer molecules which are stably dispersed in the ink without the need for a dispersing agent. Water dispersible polyurethanes employed in the present invention may have the general formula of (I)

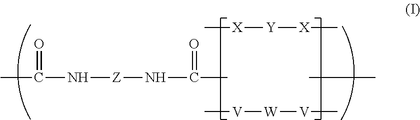

wherein Z in the structure (I) above is the central portion of the monomer unit that is the polymerization product of a diisocyanate; X-Y-X represents a soft segment comprising at least siloxane groups; W is the central portion of a unit containing an acid group; and X and V can be the same or different and are an —O— or —N— atom.

Z is desirably a hydrocarbon group having a valence of two, more desirably containing a substituted or unsubstituted alicyclic, aliphatic, or aromatic group, desirably represented by one or more of the following structures:

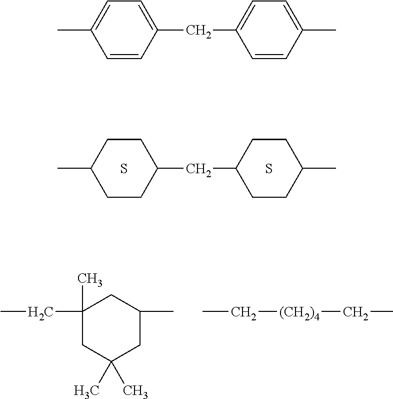

In one embodiment, X-Y-X desirably represents a segment derived from a polysiloxane group-containing prepolymer, and in a specific embodiment a polydimethyl siloxane (PDMS) group-containing prepolymer. The polysiloxane segment may be introduced into the polyurethane by using the prepolymer with both ends terminated with a hydroxyl (diol) or an amino (diamine) group. The prepolymer having terminal hydroxyl groups may be, e.g., a silanol or carbinol terminated polydimethyl siloxane, and that having terminal amine groups may be, e.g., an aminoalkyl terminated polydimethyl siloxane. The resulting polyurethanes are herein referred to as siloxane group functionalized, since they contain siloxane groups as part of the polymer composition.

Exemplary polysiloxane prepolymers useful as segment X-Y-X include those having the generic formulas IIa and IIb:

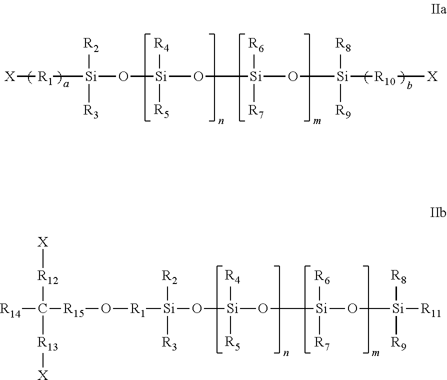

Where, R₁ and R₁₀ are each alkyl or oxyalkylene having from 1 to 10 carbon atoms, a and b are each zero or 1, R₂, R₃, R₄, R₅, R₆, R₇, R₈, R₉, R₁₁, R₁₂, R₁₃, R₁₄ and R₁₅ are each independently an alkyl, aryl, or arylalkyl group, the alkyl group containing 1 to 6 carbon atoms, and n and m are each from 0 to about 1000, such that the value of n+m is from about 4 to about 1000.

The incorporation of soft segments of generic formula IIb into the polyurethane results in siloxane groups that are pendant (grafted) to the polymer backbone. Soft segments introduced by formula IIa result in siloxane groups that are part of the polymer backbone.

Silanol terminated PDMS prepolymers useful as soft segment X-Y-X are exemplified by compounds of formula IIa-1, IIa-2, IIa-3.

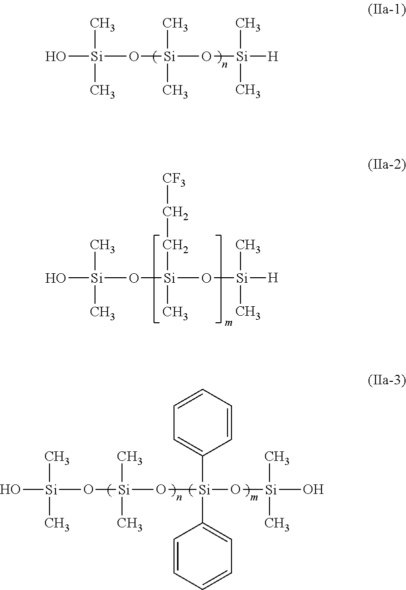

Another example of a group useful for X-Y-X is shown by formula IIb-1, where n provides the compound with a molecular weight from about 500 to about 100,000. Examples of compounds useful as structure IIb-1 include the SILAPLANE® FM-DA11, FM-DA-21, and FMDA-26 from Chisso America, Inc.

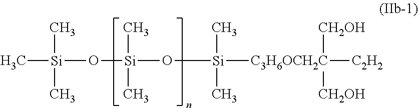

Aminoalkyl terminated PDMS prepolymers useful as soft segment X-Y-X are exemplified by Formula III. The incorporation of aminoalkyl terminated PDMS prepolymers into the polyurethane results in the formation of urea bonds in the polymer.

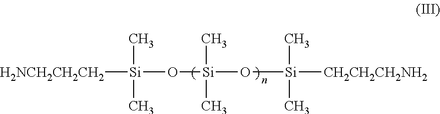

In accordance with the invention, the polyurethane additive employed in the inkjet ink comprises polyurethane polymer chains including at least first segments having a polysiloxane group of weight average molecular weight greater than about 10,000 daltons pendant to the polyurethane polymer chain backbone. This may be achieved, e.g., by employing siloxane prepolymers of formula IIb (or more specifically, e.g., PDMS prepolymers of formula IIb-1) in the preparation of the polyurethane, wherein the siloxane prepolymer is selected to be of sufficiently high weight average molecular weight. In specific embodiments, the polyurethane polymer chains include at least first segments having a polysiloxane group of weight average molecular weight of from between 10,000 and about 100,000 daltons pendant to the polyurethane polymer chain backbone. Such relatively high molecular weight polysiloxane segments are preferably present in the polyurethane polymer additive at from 1% to 30%, more preferably 2% to 29%, more preferably 5% to 25%, and most preferably 6% to 15% by weight of the total polyurethane polymer.

Further in accordance with the invention, (i) the polyurethane polymer additive further comprises polyurethane polymer chains including second segments having a polysiloxane group of a relatively lower weight average molecular weight less than about 6,000 daltons, preferably of from about 500 to about 5,000 daltons and more preferably of from about 500 to 3,000 daltons, either pendant to the polyurethane polymer backbone or a part of the polyurethane polymer backbone, or (ii) the composition further comprises a polysiloxane polymer additive of such relatively lower weight average molecular weight of less than about 6,000 daltons which is not pendant to a polyurethane polymer backbone or a part of a polyurethane polymer backbone. Such alternative requirement (i) may be achieved, e.g., by further employing a siloxane prepolymer of either of the above formula IIa or IIb (or more specifically, e.g., a PDMS prepolymer of formula IIa-1, IIa-2, IIa-3, IIb-1 or III), selected to be of sufficiently low weight average molecular weight, in combination with the siloxane prepolymer selected to be of sufficiently high weight average molecular weight, as co-reactants in the preparation of the polyurethane polymer. Alternative requirement (ii) may be achieved, e.g., by employing a siloxane prepolymer of either of the above formula IIa or IIb (or more specifically, e.g., a PDMS prepolymer of formula IIa-1, IIa-2, IIa-3, IIb-1 or III), selected to be of sufficiently low weight average molecular weight, as a separate polymer additive in the ink composition containing a polyurethane polymer comprising only the relatively higher weight average molecular weight siloxane group. In specific embodiments, the relatively lower molecular weight polysiloxane segments are preferably present in the polyurethane polymer additive at from 1% to 30%, more preferably 1% to 15%, more preferably 1% to 10%, more preferably 1% to 5%, and most preferably 1% to 4% by weight of the total polyurethane polymer (or alternatively as a distinct polysiloxane polymer percentage of the combined weight of the polyurethane and a distinct polysiloxane polymer). Although the present claimed invention requires that either of alternative requirements (i) and (ii) be satisfied, both of such features may simultaneously be satisfied in a further embodiment of the invention.

The polysiloxane segments can be silanol terminated, carbinol terminated or aminoalkyl terminated polysiloxane prepolymers. X-Y-X in the above formula can include a mixture of one or more silanol or carbinol terminated polysiloxane prepolymer and one or more aminoalkyl terminated polysiloxane prepolymer. X-Y-X can also include a mixture of segments comprising silanol, carbinol, or aminoalkyl terminated polysiloxane prepolymers and at least one further segment comprising polyol or polyamine prepolymer selected from fluorinated polyether polyols, polyether polyols, polyester polyols, polycarbonate polyols, polycarprolactone polyols, polyether diamines, polyester diamines, or polycarbonate diamines. When the polysiloxane prepolymer is used in combination with a polyether, polyfluoroether, polyester or polycarbonate prepolymer to form the polyurethane or a polyurethaneurea, it is desired that the polyether, polyfluoroether, polyester or polycarbonate prepolymer has a molecular weight from 400 to 3000 and more desirably from 1000 to 2500. Preferred polyether diols and diamines are those sold under the tradename TERATHANE® from Dupont and tradename JEFFAMINE® D, ED, and M series from Huntsman. A polyether polyol useful for the further segment is tetraethylene glycol and can desirably have a molecular weight between 600 and 2500. A useful polyether diamine is bis(3-aminopropyl) terminated polytetrahydrofuran. The further segment comprising polyether, polyester, fluorinated polyether, polycarbonate polyol or polyamine may preferably be present in the polyurethane at from 2% to 50% by weight, more desirably from 5% to 40% and most desirably from 10% to 35% based on the total weight of the polyurethane polymer additive.

Polyurethanes employed in the present invention preferably comprise sufficient total amounts of silanol or carbinol terminated polysiloxane or aminoalkyl terminated polysiloxane prepolymers such that the polysiloxane containing prepolymers are present in the final polyurethane at levels greater than or equal to 2% by weight based on the initial monomer feeds in the polymerization. More desirably, the final polymer contains greater than or equal to 5% by weight polysiloxane prepolymers and most desirably greater than or equal to about 10% by weight polysiloxane prepolymers. Polysiloxane modified polyurethanes in accordance with the present invention when formulated into an inkjet ink provide significant improvements to the abrasion resistance of printed images especially at short time scales after printing. Polyurethanes employed in the present invention preferably comprise an upper limit of about 30% by weight total polysiloxane prepolymers and more desirably an upper limit of less than or equal to 20% by weight polysiloxane prepolymers. The relatively higher molecular weight polysiloxane first segments and relatively lower molecular weight second segments (or relatively lower molecular weight distinct polysiloxane polymer) are each preferably present in the polyurethane polymer additive at greater than or equal to 1% by weight of the total polyurethane polymer and any added distinct polysiloxane polymer. The first segments are further preferably present in the polyurethane polymer additive at a wt % greater than or equal to that of the second segments, and the total amount of the first segments and second segments (or relatively lower molecular weight distinct polysiloxane polymer) in the polyurethane polymer additive is preferably between 2% and 30% by weight of the total polyurethane polymer and any added distinct polysiloxane polymer.

W is desirably the central portion of a monomeric unit containing a phosphoric acid, carboxylic acid or sulfonic acid group, most desirably being carboxylic acids, such as 2,2′-bis(hydroxymethyl)propionic acid, 2,2′-bis(hydroxymethyl)butoric acid, and hydroxyethylether of 4,4′-bis(4-hydroxyphenyl)valeric acid.

Conventional processes of making polyurethane dispersions involve the steps of preparing a prepolymer having a relatively low molecular weight and a small excess of isocyanate groups and chain-extending with a chain extender the prepolymers into a high molecular weight polyurethane during the dispersion process. Besides the raw materials the polyurethane dispersions sold by various manufactures differ in the process used to prepare the prepolymers (e.g. Solvent free prepolymer process, Ketimine and Ketazine process, Hybrid system, and Ethyl acetate process) and the type of chain extender used in the dispersion step. Such materials and processes have been disclosed in, for example, U.S. Pat. No. 4,335,029 by Dadi, et al. assigned to Witco Chemical Corporation (New York, N.Y.); in “Aqueous Polyurethane Dispersions” by B. K. Kim, Colloid & Polymer Science, Vol. 274, No. 7 (1996) 599-611© Steinopff Verlag 1996; and in “Polyurethane Dispersion Process)” by Manea et al. Paint and Coating Industry, January 200, Page 30.

The polyurethane dispersions useful for the practice of this invention are desirably prepared without involving the chain-extension step during the dispersion step. Instead it prefers to have the chemical reaction for forming urethane or urea linkages completed prior to the dispersion step. This will insure that the polyurethane dispersions used in the ink compositions of the invention have well controlled molecular weight and molecular weight distribution and be free of gel particles.

In one particularly useful process, the polyurethane used in the present invention is prepared in a water miscible organic solvent such as tetrahydrofuran, followed by neutralizing the hydrophilic groups, e.g. carboxylic acid groups, with an aqueous inorganic base, e.g. potassium hydroxide solution. The polyurethane solution is then diluted with doubly distilled de-ionized water. Finally the water miscible organic solvent is removed by distillation to form stable polyurethane dispersions. In this process the polyurethane particles are formed by precipitation during solvent evaporation.

In a second desirable process the polyurethane useful for the invention is prepared in a water immiscible organic solvent, e.g. ethyl acetate. The polyurethane is neutralized with an aqueous inorganic base and water is added to form an aqueous dispersion comprising primarily minute drops of polyurethane-water immiscible organic solvent solution suspended in water. The water immiscible organic solvent is then removed to form the desired polyurethane dispersion.

In another desirable process the polyurethane is formed by a sequential polymerization process where a soft polyurethane segment is formed first by reacting a diisocyanate compound with a carbinol or silanol terminated diol or aminoalkyl siloxane diamine. The soft polyurethane segment then reacts further with a mixture of diisocyanate compound, a siloxane or polyether polyol, and a low molecular weight diol having a hydrophilic group, e.g. a carboxylic acid group.

The polyurethane of this invention has a sufficient amount of acid groups in the molecule to make the polymer usable in an aqueous-based ink. In one embodiment the polyurethane has an acid number of greater than or equal to 20. In order to achieve optimal jetting from an inkjet printhead the acid number is typically from 50 to 160, more usefully from 60 to 160 and more desirably from 60 to 130. The acid number is defined as the milligrams of potassium hydroxide required to neutralize one gram of dry polymer. The acid number of the polymer may be calculated by the formula given in the following equation: Acid number=(moles of acid monomer)*(56 grams/mole)*(1000)/(total grams of monomers) where, moles of acid monomer is the total moles of all acid group containing monomers that comprise the polymer, 56 is the formula weight for potassium hydroxide and total grams of monomers is the summation of the weight of all the monomers, in grams, comprising the target polymer.

The acid groups on the polyurethane compounds of the present invention are at least partially neutralized (converted into salts) using monovalent inorganic base, desirably an alkaline metal hydroxide selected from the group of potassium hydroxide, sodium hydroxide, rubidium hydroxide or lithium hydroxide. In a preferred embodiment, at least 70 percent of the available acid groups on the polymer are converted into salts using inorganic base, more desirably at least 90% of the available acid groups are converted. From a manufacturing perspective, desirably less than 100% of the acid groups are neutralized as this can lead to lack of control of the pH of the inks.

Measurements of the molecular weight of the polyurethane of this invention by well known methods such as gel permeation chromatography show that the polymer is composed of a distribution of polymer chains of varying molecular weight. Within a given polymer composition, there may be a broad distribution of chains with molecular weights less than 10,000 to well over 100,000. The chemical composition of the various chains may also vary. The polyurethanes employed in this invention will typically have a higher concentration of the relatively higher molecular weight polysiloxane segment in the high molecular weight fraction of the molecular weight distribution of polymer chains. The lower molecular weight fraction will typically contain more of the relatively lower molecular weight polysiloxane segments (when incorporated into the polyurethane) and very little of the relatively higher Mw polysiloxane segment. This difference in composition and molecular weight within the normal distribution of polymer chains is likely also responsible for the formation of the two dispersed phases typical of the polymers of the present invention.

The polysiloxane containing polyurethane polymers of the present invention should have a minimum weight average molecular weight of greater than about 10,000 daltons. Desirably, the polyurethane has a maximum weight average molecular weight of about 50,000 daltons. Polymers within this average molecular weight range will typically contain some fraction of high molecular weight chains with molecular weights greater than 50,000 daltons and ranging to 100,000 daltons or greater. Polyurethanes having weight average molecular weights less than 10,000 daltons may provide insufficient durability and often exhibit poor jetting performance. Weight average molecular weights above 50,000 daltons may have negative impacts on the relatively low viscosity requirements of an inkjet ink which are desirably jetted at high frequencies and with low variability, especially in thermal inkjet printheads. Other printhead designs such as piezoelectric, however, are known to successfully jet polymers of higher average molecular weights over 100,000 daltons. More typically, the weight average molecular weight of polyurethanes employed in the present invention is preferably from 10,000 to 50,000 daltons, most desirably from 15,000 to 30,000 daltons.

The polyurethane used in the invention is preferably present in the ink jet ink at a minimum of 10% by weight based on the total amount of pigments incorporated into the ink, and typically from 10 to 100% by weight based on the total amount of pigment. Pigmented inks typically contain dispersed pigment at concentrations of from about 1 to 10% by weight, and pigment concentrations of greater than or equal to about 4% by weight may be considered relatively high pigment concentrations in aqueous inkjet ink formulations. It is highly desirable to minimize the level of polyurethane in the ink relative to the amount of pigment to improve the jetting reliability of the ink, especially for relatively high pigment concentration inks. The present invention is especially effective in this regard because even low levels of the polysiloxane containing urethanes provide large improvements in abrasion durability. Thus, the use of polyurethanes in accordance with the invention is particularly effective for use with relatively high pigment concentration inks (e.g., inks with greater than or equal to about 4 weight percent pigment, and more particularly from about 4 to about 10 weight percent pigment), where the polyurethane is present at a relatively low concentration (e.g., from about 10 to about 30%) based on weight of the pigment. Pigment-based inks with such a relatively high loading of pigments enable high image quality on the widest range of print media, and the polyurethanes of the present invention enable these high pigment loaded inks to have desirable abrasion durability, while maintaining good jetting reliability and adequate long-term stability to enable efficient large-scale manufacturing.

The polyurethane dispersions useful for the practice of this invention desirably have a mean particle size of less than about 5 micrometer, more desirably less than about 1 micrometer.

Ink compositions of the present invention may comprise a mixture of a siloxane group containing polyurethane and a second polyurethane comprising soft segments having polyether, polyester, polycarbonate, polydimethylsiloxane or polycaprolactone groups. The addition of a second non-siloxane group containing polyurethane to an ink composition can have the advantage of improving the jetting velocity of the ink or tailoring an aspect of the durability on a given substrate.

The pigment-based ink compositions of the present invention also desirably comprise a water-soluble acrylic polymer comprising carboxylic acid groups added as a free polymer or as the dispersing agent for the pigment particles. The term “water-soluble” is meant herein that when the polymer is dissolved in water and when the polymer is at least partially neutralized with an inorganic monovalent base the resultant solution is visually clear.

The monomers for the water-soluble acrylic polymer can be selected from methyl methacrylate, ethyl methacrylate, butyl methacrylate, ethyl acrylate, butyl acrylate, hexyl acrylate, n-octyl acrylate, lauryl methacrylate, 2-ethylhexyl methacrylate, nonyl acrylate, benzyl methacrylate, 2-hydroxypropyl methacrylate, acrylonitrile, methacrylonitrile, vinyl acetate, vinyl propionate, vinylidene chloride, vinyl chloride, styrene, a-methyl styrene, t-butyl styrene, vinyl toluene, butadiene, isoprene, N,N-dimethyl acrylamide, acrylic acid, methacrylic acid, chloromethacrylic acid, maleic acid and derivatives thereof. Examples of suitable monomers include allyl compounds such as allyl esters (e.g., allyl acetate, allyl caproate, etc.); vinyl ethers (e.g., methyl vinyl ether, butyl vinyl ether, methoxyethyl vinyl ether, ethoxyethyl vinyl ether, chloroethyl vinyl ether, 1-methyl-2,2-dimethylpropyl vinyl ether, hydroxyethyl vinyl ether, diethylene glycol vinyl ether, dimethylaminoethyl vinyl ether, butylaminoethyl vinyl ether, benzyl vinyl ether, tetrahydrofurfuryl vinyl ether, etc.); vinyl esters (such as vinyl acetate, vinyl propionate, vinyl butyrate, vinyl isobutyrate, vinyl dimethyl propionate, vinyl ethyl butyrate, vinyl chloroacetate, vinyl dichloroacetate, vinyl methoxyacetate, vinyl phenyl acetate, vinyl acetoacetate, etc.); vinyl heterocyclic compounds (such as N-vinyl oxazolidone, N-vinylimidazole, N-vinylpyrrolidone, N-vinylcarbazole, vinyl thiophene, N-vinylethyl acetamide, etc.); styrenes (e.g., styrene, divinylbenzene, methylstyrene, dimethylstyrene, ethylstyrene, isopropylstyrene, sodium styrenesulfonate, potassium styrenesulfinate, butylstyrene, hexylstyrene, cyclohexylstyrene, benzylstyrene, chloromethylstyrene, trifluoromethylstyrene, acetoxymethylstyrene, acetoxystyrene, vinylphenol, (t-butoxycarbonyloxy) styrene, methoxystyrene, 4-methoxy-3-methylstyrene, dimethoxystyrene, chlorostyrene, dichlorostyrene, trichlorostyrene, bromostyrene, iodostyrene, fluorostyrene, methyl vinylbenzoate ester, vinylbenzoic acid, etc.); crotonic acids (such as crotonic acid, crotonic acid amide, crotonate esters (e.g., butyl crotonate, etc.)); vinyl ketones (e.g., methyl vinyl ketone, etc); olefins (e.g., dicyclopentadiene, ethylene, propylene, 1-butene, 5,5-dimethyl-1-octene, etc.); itaconic acids and esters (e.g., itaconic acid, methyl itaconate, etc.), other acids such as sorbic acid, cinnamic acid, methyl sorbate, citraconic acid, chloroacrylic acid mesaconic acid, maleic acid, fumaric acid, and ethacrylic acid; halogenated olefins (e.g., vinyl chloride, vinylidene chloride, etc.); unsaturated nitriles (e.g., acrylonitrile, etc.); acrylic or methacrylic acids and esters (such as acrylic acid, methyl acrylate, methacrylic acid, methyl methacrylate, ethyl acrylate, butyl acrylate, butyl methacrylate, 2-hydroxyethyl methacrylate, 2-acetoacetoxyethyl methacrylate, sodium-2-sulfoethyl acrylate, 2-aminoethylmethacrylate hydrochloride, glycidyl methacrylate, ethylene glycol dimethacrylate, etc.); and acrylamides and methacrylamides (such as acrylamide, methacrylamide, N-methylacrylamide, N,N-dimethylacrylamide, N-isopropylacrylamide, N-s-butylacrylamide, N-t-butylacrylamide, N-cyclohexylacrylamide, N-(3-aminopropyl)methacrylamide hydrochloride, N-(3-dimethylaminopropyl)methacrylamide hydrochloride, N,N-dipropylacrylamide, N-(1,1-dimethyl-3-oxobutyl)acrylamide, N-(1,1,2-trimethylpropyl)acrylamide, N-(1,1,3,3-tetramethylbutyl)acrylamide, N-(1-phthalamidomethyl)acrylamide, sodium N-(1,1-dimethyl-2-sulfoethyl)acrylamide, N-butylacrylamide, N-(1,1-dimethyl-3-oxobutyl)acrylamide, N-(2-carboxyethyl)acrylamide, 3-acrylamido-3-methylbutanoic acid, etc.).

The water-soluble acrylic polymer can be prepared by emulsion polymerization, solution polymerization or bulk polymerization technique well known in the art. Desirably, the water-soluble acrylic polymer has a weight average molecular weight of less than 20,000. Desirably, the polymer has a sufficient number of acid groups such that the acid number of the polymer is greater than 115.

The acid groups on the acrylic polymers are at least partially neutralized (converted into salts) using monovalent inorganic bases, desirably aqueous alkaline metal hydroxides, selected from; potassium hydroxide, sodium hydroxide, rubidium hydroxide or lithium hydroxide. In a preferred embodiment, at least 70 percent of the available acid groups on the polymer are converted into salts using monovalent inorganic base, more desirably at least 90% of the available acid groups are converted. Monovalent inorganic bases are highly preferred over organic bases such as amines as the neutralizing agents for the acrylic polymers since inks containing acrylic polymers neutralized with organic amines show very poor jetting performance in a thermal ink jet printhead.

Additional polymers that may be employed in the present invention are exemplified by those disclosed in U.S. Pat. No. 6,866,379, which is incorporated herein in their entirety by reference. Specific examples of preferred water-soluble polymers useful in the present invention are copolymers prepared from at least one hydrophilic monomer that is an acrylic acid or methacrylic acid monomer, or combinations thereof. Desirably, the hydrophilic monomer is methacrylic acid.

Preferred water-soluble polymers useful in the present invention are copolymers prepared from at least one hydrophobic monomer that is an (meth)acrylic acid ester. Examples of hydrophobic monomers include, methyl (meth)acrylate, ethyl (meth)acrylate, butyl (meth)acrylate, octyl (meth)acrylate, decyl (meth)acrylate, lauryl(methacrylate), stearyl (meth)acrylate, benzyl (meth)acrylate, phenyl (meth)acrylate, or combinations thereof. Preferred hydrophobic monomers are benzyl (meth)acrylate

The water-soluble polymer may also be a styrene-acrylic copolymer comprising a mixture of vinyl or unsaturated monomers, including at least one styrenic monomer and at least one acrylic monomer, at least one of which monomers has an acid or acid-providing group. Such polymers are disclosed in, for example, U.S. Pat. Nos. 4,529,787; 4,358,573; 4,522,992; 4,546,160; the disclosures of which are incorporated herein by reference. Preferred polymers include, for example, styrene-acrylic acid, styrene-acrylic acid-alkyl acrylate, styrene-maleic acid, styrene-maleic acid-alkyl acrylate, styrene-methacrylic acid, styrene-methacrylic acid-alkyl acrylate, and styrene-maleic acid half ester, wherein each type of monomer may correspond to one or more particular monomers. Examples of preferred polymers include but are not limited to styrene-acrylic acid copolymer, (3-methyl styrene)-acrylic acid copolymer, styrene-methacrylic acid copolymer, styrene-butyl acrylate-acrylic acid terpolymer, styrene-butyl methacrylate-acrylic acid terpolymer, styrene-methyl methacrylate-acrylic acid terpolymer, styrene-butyl acrylate-ethyl acrylate-acrylic acid tetrapolymer and styrene-(α-methylstyrene)-butyl acrylate-acrylic acid tetrapolymer.

The water-soluble acrylic polymer is not limited in the arrangement of the monomers comprising the copolymer. The arrangement of monomers may be totally random, or they may be arranged in blocks such as AB or ABA wherein, A is the hydrophobic monomer and B is the hydrophilic monomer. In addition, the polymer make take the form of a random terpolymer or an ABC triblock wherein, at least one of the A, B and C blocks is chosen to be the hydrophilic monomer and the remaining blocks are hydrophobic blocks dissimilar from one another.

The water-soluble acrylic polymer useful in the pigment-based inks of the present invention is desirably present in the pigment based ink jet ink at a concentration of greater than 0.6 weight percent based on the total weight of the ink. In a preferred embodiment of the present invention the ink composition comprises a polyurethane described above and a water-soluble polymer described above wherein, the ratio of total amount of polyurethane and acrylic polymer(s) to pigment is from 0.5 to 1.5 and the ratio of polyurethane polymer to acrylic polymer is from 0.5 to 2. The use of acrylic polymer in the clear ink is optional.

In another useful embodiment, the components of the ink composition are selected such that the ink viscosity is less than 4.0 centipoise at 25 degrees Celsius, typically less than 3.5, and suitably less than 3.0. Ink compositions defined by these preferred embodiments are capable of achieving high firing frequencies with low variability for a large number of firing events.

Surfactants may be added to adjust the surface tension of the ink to an appropriate level. In a particular embodiment, relative dynamic and static surface tensions of various pigment based inks and clear protective ink of an ink set may be controlled as described in U.S. Patent Application Pub. No. 2008/0207805, the disclosure of which is incorporated by reference herein, to control intercolor bleed between the inks. The surfactants may be anionic, cationic, amphoteric or nonionic and used at levels of 0.01 to 5% of the ink composition. Examples of suitable nonionic surfactants include, linear or secondary alcohol ethoxylates (such as the Tergitol® 15-S and Tergitol® TMN series available from Union Carbide and the Brij® series from Uniquema), ethoxylated alkyl phenols (such as the Triton® series from Union Carbide), fluoro surfactants (such as the Zonyls® from DuPont; and the Fluorads® from 3M), fatty acid ethoxylates, fatty amide ethoxylates, ethoxylated and propoxylated block copolymers (such as the Pluronic® and Tetronic® series from BASF, ethoxylated and propoxylated silicone based surfactants (such as the Silwet® series from CK Witco), alkyl polyglycosides (such as the Glucopons® from Cognis) and acetylenic polyethylene oxide surfactants (such as the Surfynols from Air Products).

Examples of anionic surfactants include; carboxylated (such as ether carboxylates and sulfosuccinates), sulfated (such as sodium dodecyl sulfate), sulfonated (such as dodecyl benzene sulfonate, alpha olefin sulfonates, alkyl diphenyl oxide disulfonates, fatty acid taurates and alkyl naphthalene sulfonates), phosphated (such as phosphated esters of alkyl and aryl alcohols, including the Strodex® series from Dexter Chemical), phosphonated and amine oxide surfactants and anionic fluorinated surfactants. Examples of amphoteric surfactants include; betaines, sultaines, and aminopropionates. Examples of cationic surfactants include; quaternary ammonium compounds, cationic amine oxides, ethoxylated fatty amines and imidazoline surfactants. Additional examples are of the above surfactants are described in “McCutcheon's Emulsifiers and Detergents: 1995, North American Editor”.

A biocide (0.01-1.0% by weight) may also be added to prevent unwanted microbial growth which may occur in the ink over time. A preferred biocide for the inks employed in the present invention is Proxel® GXL (Zeneca Colours Co.) at a concentration of 0.05-0.1% by weight or/and Kordek® (Rohm and Haas Co.) at a concentration of 0.05-0.1% by weight (based on 100% active ingredient. Additional additives which may optionally be present in an ink jet ink composition include thickeners, conductivity enhancing agents, anti-kogation agents, drying agents, waterfast agents, dye solubilizers, chelating agents, binders, light stabilizers, viscosifiers, buffering agents, anti-mold agents, anti-curl agents, stabilizers and defoamers.

The pH of the aqueous ink compositions of the invention may be adjusted by the addition of organic or inorganic acids or bases. Inorganic bases are preferred, however, small amounts of organic bases, such as triethanolamine, may be used to adjust the pH of the ink. Useful inks may have a preferred pH of from 4 to 10, depending upon the type of pigment being used. Desirably, the pH of the present ink is from 6 to 9, and suitably from 7.5 to 8.5. Inks of the present invention may optionally contain multivalent cations such as, e.g., calcium, magnesium, copper, nickel, barium, and aluminum, at levels, e.g., between 10 and 1000 parts per million.

The inks of the present invention can be printed through an ink jet printhead capable of achieving firing frequencies of at least 12 kHz with a near nozzle velocity of at least 10 meters/second. Any of the known printhead designs in the art of ink jet printing may be used which are capable of achieving these high speed firing frequencies. Desirably, the IJ printer is equipped with a thermal ink jet printhead. Particularly preferred printhead designs are disclosed in United States Patent Application Pub. Nos. 2006/0103691 and 2008/0136867, the disclosures of which are incorporated by reference herein.

The inks of the present invention may be applied to a photoglossy or plain paper receiver. The two types of receivers are distinguished from one another in that the photoglossy receiver is manufactured with a coated layer above the underlying paper support. Examples of plain papers include; Kodak bright white ink jet paper, Hewlett Packard Color ink jet paper, Xerox Extra Bright white ink jet paper, Georgia-Pacific ink jet Paper Catalog Number 999013, Staples ink jet paper International Paper Great White MultiUse 20 Paper, Xerox Premium Multipurpose Paper, Hammermill Copy plus or ForeMP paper, and Hewlett Packard Multipurpose paper. The plain papers may include papers that have been treated with water soluble salts of divalent or multivalent metal ions during or after manufacture of the paper.

Inks of the present invention can be printed as digital images having photographic quality if a suitable recording medium, such as glossy ink jet paper, is used. Photoglossy receivers may be further categorized as being a swellable media (having a non-porous polymer coating) or a microporous media, although hybrid designs are also well known. The microporous media typically comprise water-absorbing fine particles or powders mixed with a polymeric hydrophilic binder to form a microporous structured coating. The hydrophilic particles or powders are typically polycrystalline inorganic materials such as boehmite alumina, fumed alumina or fumed silica or amorphous inorganic materials such as aluminum silicates or silica gel. Microporous photoglossy media are preferred due to their relatively quick drying capabilities and improved water-fastness and smudge resistance compared to swellable media. The designs of both plain paper and photoglossy media vary widely depending on materials and paper manufacturing processes and should not be construed to limit the scope of the present invention.

Unless otherwise specifically stated, use of the term “substituted” or “substituent” means any group or atom other than hydrogen. Additionally, when the term “group” is used, it means that when a substituent group contains a substitutable hydrogen, it is also intended to encompass not only the substituent's unsubstituted form, but also its form further substituted with any substituent group or groups as herein mentioned, so long as the substituent does not destroy properties necessary for device utility. Suitably, a substituent group may be halogen or may be bonded to the remainder of the molecule by an atom of carbon, silicon, oxygen, nitrogen, phosphorous, sulfur, selenium, or boron. The substituent may be, for example, halogen, such as chloro, bromo or fluoro; nitro; hydroxyl; cyano; carboxyl; or groups which may be further substituted, such as alkyl, including straight or branched chain or cyclic alkyl, such as methyl, trifluoromethyl, ethyl, t-butyl, 3-(2,4-di-t-pentylphenoxy)propyl, and tetradecyl; alkenyl, such as ethylene, 2-butene; alkoxy, such as methoxy, ethoxy, propoxy, butoxy, 2-methoxyethoxy, sec-butoxy, hexyloxy, 2-ethylhexyloxy, tetradecyloxy, 2-(2,4-di-t-pentylphenoxy)ethoxy, and 2-dodecyloxyethoxy; aryl such as phenyl, 4-t-butylphenyl, 2,4,6-trimethylphenyl, naphthyl; aryloxy, such as phenoxy, 2-methylphenoxy, alpha- or beta-naphthyloxy, and 4-tolyloxy; carbonamido, such as acetamido, benzamido, butyramido, tetradecanamido, alpha-(2,4-di-t-pentyl-phenoxy)acetamido, alpha-(2,4-di-t-pentylphenoxy)butyramido, alpha-(3-pentadecylphenoxy)-hexanamido, alpha-(4-hydroxy-3-t-butylphenoxy)-tetradecanamido, 2-oxo-pyrrolidin-1-yl, 2-oxo-5-tetradecylpyrrolin-1-yl, N-methyltetradecanamido, N-succinimido, N-phthalimido, 2,5-dioxo-1-oxazolidinyl, 3-dodecyl-2,5-dioxo-1-imidazolyl, and N-acetyl-N-dodecylamino, ethoxycarbonylamino, phenoxycarbonylamino, benzyloxycarbonylamino, hexadecyloxycarbonylamino, 2,4-di-t-butylphenoxycarbonylamino, phenylcarbonylamino, 2,5-(di-t-pentylphenyl)carbonylamino, p-dodecyl-phenylcarbonylamino, p-tolylcarbonylamino, N-methylureido, N,N-dimethylureido, N-methyl-N-dodecylureido, N-hexadecylureido, N,N-dioctadecylureido, N,N-dioctyl-N′-ethylureido, N-phenylureido, N,N-diphenylureido, N-phenyl-N-p-tolylureido, N-(m-hexadecylphenyl)ureido, N,N-(2,5-di-t-pentylphenyl)-N′-ethylureido, and t-butylcarbonamido; sulfonamido, such as methylsulfonamido, benzenesulfonamido, p-tolylsulfonamido, p-dodecylbenzenesulfonamido, N-methyltetradecylsulfonamido, N,N-dipropyl-sulfamoylamino, and hexadecylsulfonamido; sulfamoyl, such as N-methylsulfamoyl, N-ethylsulfamoyl, N,N-dipropylsulfamoyl, N-hexadecylsulfamoyl, N,N-dimethylsulfamoyl, N-[3-(dodecyloxy)propyl]sulfamoyl, N-[4-(2,4-di-t-pentylphenoxy)butyl]sulfamoyl, N-methyl-N-tetradecylsulfamoyl, and N-dodecylsulfamoyl; carbamoyl, such as N-methylcarbamoyl, N,N-dibutylcarbamoyl, N-octadecylcarbamoyl, N-[4-(2,4-di-t-pentylphenoxy)butyl]carbamoyl, N-methyl-N-tetradecylcarbamoyl, and N,N-dioctylcarbamoyl; acyl, such as acetyl, (2,4-di-t-amylphenoxy)acetyl, phenoxycarbonyl, p-dodecyloxyphenoxycarbonyl methoxycarbonyl, butoxycarbonyl, tetradecyloxycarbonyl, ethoxycarbonyl, benzyloxycarbonyl, 3-pentadecyloxycarbonyl, and dodecyloxycarbonyl; sulfonyl, such as methoxysulfonyl, octyloxysulfonyl, tetradecyloxysulfonyl, 2-ethylhexyloxysulfonyl, phenoxysulfonyl, 2,4-di-t-pentylphenoxysulfonyl, methylsulfonyl, octylsulfonyl, 2-ethylhexylsulfonyl, dodecylsulfonyl, hexadecylsulfonyl, phenylsulfonyl, 4-nonylphenylsulfonyl, and p-tolylsulfonyl; sulfonyloxy, such as dodecylsulfonyloxy, and hexadecylsulfonyloxy; sulfinyl, such as methylsulfinyl, octylsulfinyl, 2-ethylhexylsulfinyl, dodecylsulfinyl, hexadecylsulfinyl, phenylsulfinyl, 4-nonylphenylsulfinyl, and p-tolylsulfinyl; thio, such as ethylthio, octylthio, benzylthio, tetradecylthio, 2-(2,4-di-t-pentylphenoxy)ethylthio, phenylthio, 2-butoxy-5-t-octylphenylthio, and p-tolylthio; acyloxy, such as acetyloxy, benzoyloxy, octadecanoyloxy, p-dodecylamidobenzoyloxy, N-phenylcarbamoyloxy, N-ethylcarbamoyloxy, and cyclohexylcarbonyloxy; amine, such as phenylanilino, 2-chloroanilino, diethylamine, dodecylamine; imino, such as 1 (N-phenylimido)ethyl, N-succinimido or 3-benzylhydantoinyl; phosphate, such as dimethylphosphate and ethylbutylphosphate; phosphite, such as diethyl and dihexylphosphite; a heterocyclic group, a heterocyclic oxy group or a heterocyclic thio group, each of which may be substituted and which contain a 3 to 7 membered heterocyclic ring composed of carbon atoms and at least one hetero atom selected from the group consisting of oxygen, nitrogen, sulfur, phosphorous, or boron. Such as 2-furyl, 2-thienyl, 2-benzimidazolyloxy or 2-benzothiazolyl; quaternary ammonium, such as triethylammonium; quaternary phosphonium, such as triphenylphosphonium; and silyloxy, such as trimethylsilyloxy.

If desired, the substituents may themselves be further substituted one or more times with the described substituent groups. The particular substituents used may be selected by those skilled in the art to attain desirable properties for a specific application and can include, for example, electron-withdrawing groups, electron-donating groups, and steric groups. When a molecule may have two or more substituents, the substituents may be joined together to form a ring such as a fused ring unless otherwise provided. Generally, the above groups and substituents thereof may include those having up to 48 carbon atoms, typically 1 to 36 carbon atoms and usually less than 24 carbon atoms, but greater numbers are possible depending on the particular substituents selected.

The following examples illustrate, but do not limit, the utility of the present invention.

### Examples

### Polyurethane Binders Used in the Examples

Unless otherwise specified the procedure for synthesizing the polyurethane of the following examples involved charging a vessel with acid containing diol and PDMS or polyether amine or diol, followed by addition of diiosocyanate and subsequent polymerization.

### Weight Average Molecular Weight

Samples of the polyurethanes were analyzed using size-exclusion chromatography (SEC) at 35.0 C in tetrahydrofuran (THF) containing 1.0% formic acid. The column set consists of three 7.5 mm×300 mm Plgel mixed-B columns from Polymer Laboratories (Varian, Inc.), calibrated with narrow-molecular-weight distribution polystyrene standards.

Comparative Polyurethane PU-1: A polyurethane was made by polymerizing, 39% isophorone diisocyanate, 24% 2,2-bis(hydroxymethyl) propionic acid (DMPA), and 37% of a 2000 Mw polytetrahydrofuran polyol. The resulting 100-acid number polyurethane had a weight average molecular weight of 18,000 and 95% of the acid groups were neutralized with potassium hydroxide.

Comparative Polyurethane PU-2: A polyurethane was made by polymerizing, 40.6% isophorone diisocyanate, 24% 2,2-bis(hydroxymethyl) propionic acid (DMPA), 25% of a 2000 Mw polytetrahydrofuran polyol, and 10.4% siloxane functionalized diol having a molecular weight of 15,000 (SILAPLANE FM-DA26® Chisso America, Inc.). The ratio of isocyanate to reactive hydroxyl groups (NCO/OH) was 0.95. The resulting 100-acid number polyurethane had a weight average molecular weight of 17,600 and 95% of the acid groups were neutralized with potassium hydroxide.

Comparative Polyurethane PU-3: A polyurethane was made by polymerizing, 42.4% isophorone diisocyanate, 24% 2,2-bis(hydroxymethyl) propionic acid (DMPA), 23.2% of a 2000 Mw polytetrahydrofuran polyol, and 10.4% siloxane functionalized diol having a molecular weight of 1000 (SILAPLANE FM-DA11® Chisso America, Inc.). The ratio of isocyanate to reactive hydroxyl groups (NCO/OH) was 0.95. The resulting 100-acid number polyurethane had a weight average molecular weight of 17,500 and 95% of the acid groups were neutralized with potassium hydroxide.

Comparative Polyurethane PU-4: A polyurethane was made by polymerizing, 40.7% isophorone diisocyanate, 24% 2,2-bis(hydroxymethyl) propionic acid (DMPA), 24.5% of a 2000 Mw polytetrahydrofuran polyol, and 10.8% siloxane functionalized diol having a molecular weight of 5000 (SILAPLANE FM-DA21® Chisso America, Inc.). The ratio of isocyanate to reactive hydroxyl groups (NCO/OH) was 0.95. The resulting 100-acid number polyurethane had a weight average molecular weight of 18,800 and 95% of the acid groups were neutralized with potassium hydroxide.

Comparative Polyurethane PU-5: A polyurethane was made by polymerizing, 39.6% isophorone diisocyanate, 24% 2,2-bis(hydroxymethyl) propionic acid (DMPA), 26% of a 2000 Mw polytetrahydrofuran polyol, and 10.4% siloxane functionalized diol having a molecular weight of 15,000 (SILAPLANE FM-DA26® Chisso America, Inc.). The ratio of isocyanate to reactive hydroxyl groups (NCO/OH) was 0.925. The resulting 100-acid number polyurethane had a weight average molecular weight of 14,100 and 95% of the acid groups were neutralized with potassium hydroxide.

Comparative Polyurethane PU-6: A polyurethane was made by polymerizing, 41.4% isophorone diisocyanate, 24% 2,2-bis(hydroxymethyl) propionic acid (DMPA), 24.3% of a 2000 Mw polytetrahydrofuran polyol, and 10.3% siloxane functionalized diol having a molecular weight of 15,000 (SILAPLANE FM-DA26® Chisso America, Inc.). The ratio of isocyanate to reactive hydroxyl groups (NCO/OH) was 0.975. The resulting 100-acid number polyurethane had a weight average molecular weight of 26,100 and 95% of the acid groups were neutralized with potassium hydroxide.

Comparative Polyurethane PU-7: A polyurethane was made by polymerizing, 46.3% isophorone diisocyanate, 24% 2,2-bis(hydroxymethyl) propionic acid (DMPA), 19.5% of a 2000 Mw polytetrahydrofuran polyol, and 10.2% siloxane functionalized diol having a molecular weight of 15,000 (SILAPLANE FM-DA26® Chisso America, Inc.). The ratio of isocyanate to reactive hydroxyl groups (NCO/OH) was 1.10. The resulting 100-acid number polyurethane had a weight average molecular weight of 28,000 and 95% of the acid groups were neutralized with potassium hydroxide.

Comparative Polyurethane PU-8: A polyurethane was made by polymerizing, 41.4% isophorone diisocyanate, 24% 2,2-bis(hydroxymethyl) propionic acid (DMPA), 24.3% of a 2000 Mw polytetrahydrofuran polyol, and 10.3% siloxane functionalized diol having a molecular weight of 15,000 (SILAPLANE FM-DA26® Chisso America, Inc.). The ratio of isocyanate to reactive hydroxyl groups (NCO/OH) was 0.975. The reaction was termination at about 75% of the normal reaction time by the addition of methanol. The resulting 100-acid number polyurethane had a weight average molecular weight of 16,300 and 95% of the acid groups were neutralized with potassium hydroxide.

Comparative Polyurethane PU-9: A polyurethane was made by polymerizing, 43.6% isophorone diisocyanate, 24% 2,2-bis(hydroxymethyl) propionic acid (DMPA), 22% of a 1000 Mw polytetrahydrofuran polyol, and 10.4% siloxane functionalized diol having a molecular weight of 15,000 (SILAPLANE FM-DA26® Chisso America, Inc.). The ratio of isocyanate to reactive hydroxyl groups (NCO/OH) was 0.974. The resulting 100-acid number polyurethane had a weight average molecular weight of 15,400 and 95% of the acid groups were neutralized with potassium hydroxide.

Inventive Polyurethane PU-10: A polyurethane was made by polymerizing, 42% isophorone diisocyanate, 24% 2,2-bis(hydroxymethyl) propionic acid (DMPA), 23.5% of a 2000 Mw polytetrahydrofuran polyol, 8.1% siloxane functionalized diol having a molecular weight of 15,000 (SILAPLANE FM-DA26® Chisso America, Inc.), and 2.4% of siloxane functionalized diol having a molecular weight of 1000 (SILAPLANE FM-DA11® Chisso America, Inc.). The ratio of isocyanate to reactive hydroxyl groups (NCO/OH) was 0.974. The resulting 100-acid number polyurethane had a weight average molecular weight of 27,600 and 95% of the acid groups were neutralized with potassium hydroxide.

Inventive Polyurethane PU-11: A polyurethane was made by polymerizing, 40.2% isophorone diisocyanate, 24% 2,2-bis(hydroxymethyl) propionic acid (DMPA), 25.2% of a 2000 Mw polytetrahydrofuran polyol, 8.2% siloxane functionalized diol having a molecular weight of 15,000 (SILAPLANE FM-DA26® Chisso America, Inc.), and 2.4% of siloxane functionalized diol having a molecular weight of 1000 (SILAPLANE FM-DA11® Chisso America, Inc.). The ratio of isocyanate to reactive hydroxyl groups (NCO/OH) was 0.93. The resulting 100-acid number polyurethane had a weight average molecular weight of 17,000 and 95% of the acid groups were neutralized with potassium hydroxide.

Inventive Polyurethane PU-12: A polyurethane was made by polymerizing, 38.9% isophorone diisocyanate, 24% 2,2-bis(hydroxymethyl) propionic acid (DMPA), 26.5% of a 2000 Mw polytetrahydrofuran polyol, 8.2% siloxane functionalized diol having a molecular weight of 15,000 (SILAPLANE FM-DA26® Chisso America, Inc.), and 2.4% of siloxane functionalized diol having a molecular weight of 1000 (SILAPLANE FM-DA11® Chisso America, Inc.). The ratio of isocyanate to reactive hydroxyl groups (NCO/OH) was 0.90. The resulting 100-acid number polyurethane had a weight average molecular weight of 14,000 and 95% of the acid groups were neutralized with potassium hydroxide.

Inventive Polyurethane PU-13: A polyurethane was made by polymerizing, 40.8% isophorone diisocyanate, 24% 2,2-bis(hydroxymethyl) propionic acid (DMPA), 22.7% of a 2000 Mw polytetrahydrofuran polyol, 10.4% siloxane functionalized diol having a molecular weight of 15,000 (SILAPLANE FM-DA26® Chisso America, Inc.), and 2.1% of siloxane functionalized diol having a molecular weight of 1000 (SILAPLANE FM-DA11® Chisso America, Inc.). The ratio of isocyanate to reactive hydroxyl groups (NCO/OH) was 0.95. The resulting 100-acid number polyurethane had a weight average molecular weight of 21,600 and 95% of the acid groups were neutralized with potassium hydroxide.

Inventive Polyurethane PU-14: A polyurethane was made by polymerizing, 40.9% isophorone diisocyanate, 24% 2,2-bis(hydroxymethyl) propionic acid (DMPA), 20.4% of a 2000 Mw polytetrahydrofuran polyol, 10.5% siloxane functionalized diol having a molecular weight of 15,000 (SILAPLANE FM-DA26® Chisso America, Inc.), and 4.2% of siloxane functionalized diol having a molecular weight of 1000 (SILAPLANE FM-DA11® Chisso America, Inc.). The ratio of isocyanate to reactive hydroxyl groups (NCO/OH) was 0.95. The resulting 100-acid number polyurethane had a weight average molecular weight of 22,500 and 95% of the acid groups were neutralized with potassium hydroxide.

Inventive Polyurethane PU-15: A polyurethane was made by polymerizing, 42.3% isophorone diisocyanate, 24% 2,2-bis(hydroxymethyl) propionic acid (DMPA), 23.4% of a 1000 Mw polytetrahydrofuran polyol, 8.2% siloxane functionalized diol having a molecular weight of 15,000 (SILAPLANE FM-DA26® Chisso America, Inc.), and 2.1% of siloxane functionalized diol having a molecular weight of 1000 (SILAPLANE FM-DA11® Chisso America, Inc.). The ratio of isocyanate to reactive hydroxyl groups (NCO/OH) was 0.93. The resulting 100-acid number polyurethane had a weight average molecular weight of 16,600 and 95% of the acid groups were neutralized with potassium hydroxide.

Inventive Polyurethane PU-16: A polyurethane was made by polymerizing, 41% isophorone diisocyanate, 24% 2,2-bis(hydroxymethyl) propionic acid (DMPA), 24.5% of a 2000 Mw polytetrahydrofuran polyol, 8.2% siloxane functionalized dial having a molecular weight of 15,000 (SILAPLANE FM-DA26® Chisso America, Inc.), and 2.4% of silanol terminated trifluoropropyl methylsiloxane of about 1 k Mw. (FMS-9922® Gelest, Inc.). The ratio of isocyanate to reactive hydroxyl groups (NCO/OH) was 0.95. The resulting 100-acid number polyurethane had a weight average molecular weight of 24,500 and 95% of the acid groups were neutralized with potassium hydroxide.

Inventive Polyurethane PU-17: A polyurethane was made by polymerizing, 40.5% isophorone diisocyanate, 23.9% 2,2-bis(hydroxymethyl) propionic acid (DMPA), 25.4% of a 2000 Mw polytetrahydrofuran polyol, 8.0% siloxane functionalized diol having a molecular weight of 15,000 (SILAPLANE FM-DA26® Chisso America, Inc.), and 2.2% of siloxane functionalized diol having a molecular weight of 5000 (SILAPLANE FM-DA21® Chisso America, Inc.). The ratio of isocyanate to reactive hydroxyl groups (NCO/OH) was 0.95. The resulting 100-acid number polyurethane had a weight average molecular weight of 19,100 and 95% of the acid groups were neutralized with potassium hydroxide.

Inventive Polyurethane PU-18: A polyurethane was made by polymerizing, 41% isophorone diisocyanate, 24% 2,2-bis(hydroxymethyl) propionic acid (DMPA), 24.5% of a 2000 Mw polytetrahydrofuran polyol, 8.1% siloxane functionalized diol having a molecular weight of 15,000 (SILAPLANE FM-DA26® Chisso America, Inc.), and 2.4% of a linear carbinol terminated PDMS diol of about 1 k Mw (DMS-C15® Gelest, Inc.). The ratio of isocyanate to reactive hydroxyl groups (NCO/OH) was 0.95. The resulting 100-acid number polyurethane had a weight average molecular weight of 16,800 and 95% of the acid groups were neutralized with potassium hydroxide.

Inventive Polyurethane PU-19: A polyurethane was made by polymerizing, 41% isophorone diisocyanate, 24% 2,2-bis(hydroxymethyl) propionic acid (DMPA), 24.5% of a 2000 Mw polytetrahydrofuran polyol, 8.2% siloxane functionalized dial having a molecular weight of 15,000 (SILAPLANE FM-DA26® Chisso America, Inc.), and 2.3% of hydroxyl terminated polydimethyl siloxane containing 14 to 18 mole % of diphenylsiloxane linkage having a molecular weight of 900-1000 (PDS-1615® Gelest, Inc.). The ratio of isocyanate to reactive hydroxyl groups (NCO/OH) was 0.95. The resulting 100-acid number polyurethane had a weight average molecular weight of 22,200 and 95% of the acid groups were neutralized with potassium hydroxide.

Inventive Polyurethane PU-20: A polyurethane was made by polymerizing, 40.6% isophorone diisocyanate, 24% 2,2-bis(hydroxymethyl) propionic acid (DMPA), 25.2% of a 2000 Mw polytetrahydrofuran polyol, 8.0% siloxane functionalized diol having a molecular weight of 15,000 (SILAPLANE FM-DA26® Chisso America, Inc.), and 2.2% of a silanol terminated polydimethylsiloxane of about 4.2 k Mw (DMS-S21® Gelest, Inc.). The ratio of isocyanate to reactive hydroxyl groups (NCO/OH) was 0.95. The resulting 100-acid number polyurethane had a weight average molecular weight of 19,500 and 95% of the acid groups were neutralized with potassium hydroxide.

Inventive Polyurethane PU-21: A polyurethane was made by polymerizing, 40.6% isophorone diisocyanate, 24% 2,2-bis(hydroxymethyl) propionic acid (DMPA), 25.2% of a 2000 Mw polytetrahydrofuran polyol, 8.1% siloxane functionalized diol having a molecular weight of 15,000 (SILAPLANE FM-DA26® Chisso America, Inc.), and 2.1% of aminopropyl terminated polydimethyl siloxane having a molecular weight of 3000 (DMS-A15® Gelest, Inc.). The ratio of isocyanate to reactive hydroxyl groups (NCO/OH) was 0.95. The resulting 100-acid number polyurethane had a weight average molecular weight of 22,800 and 95% of the acid groups were neutralized with potassium hydroxide.

Inventive Polyurethane PU-22: A polyurethane was made by polymerizing, 40.5% isophorone diisocyanate, 23.9% 2,2-bis(hydroxymethyl) propionic acid (DMPA), 25.4% of a 2000 Mw polytetrahydrofuran polyol, 8.0% siloxane functionalized diol having a molecular weight of 15,000 (SILAPLANE FM-DA26® Chisso America, Inc.), and 2.2% of a linear carbinol terminated PDMS diol of about 5 k Mw (DMS-C21® Gelest, Inc.). The ratio of isocyanate to reactive hydroxyl groups (NCO/OH) was 0.95. The resulting 100-acid number polyurethane had a weight average molecular weight of 18,200 and 95% of the acid groups were neutralized with potassium hydroxide.

Inventive Polyurethane PU-23: A polyurethane was made by polymerizing, 41% isophorone diisocyanate, 24% 2,2-bis(hydroxymethyl) propionic acid (DMPA), 24.9% of a 2000 Mw polytetrahydrofuran polyol, 8.12% siloxane functionalized diol having a molecular weight of 15,000 (SILAPLANE FM-DA26® Chisso America, Inc.), and 2.17% of an ethoxylate terminated perfluoro polyether diol having an average equivalent weight of about 700 (Fluorolink E10H® Solvay-Solexis, Inc.). The ratio of isocyanate to reactive hydroxyl groups (NCO/OH) was 0.95. The resulting 100-acid number polyurethane had a weight average molecular weight of 22,400 and 95% of the acid groups were neutralized with potassium hydroxide.

Inventive Polyurethane PU-24: A polyurethane was made by polymerizing, 41% isophorone diisocyanate, 24% 2,2-bis(hydroxymethyl) propionic acid (DMPA), 24.9% of a 2000 Mw polytetrahydrofuran polyol, 8.12% siloxane functionalized diol having a molecular weight of 15,000 (SILAPLANE FM-DA26® Chisso America, Inc.), and 2.23% of an hydroxymethyl terminated perfluoro polyether diol having an average equivalent weight of about 625 (Fluorolink D10H® Solvay-Solexis, Inc.). The ratio of isocyanate to reactive hydroxyl groups (NCO/OH) was 0.95. The resulting 100-acid number polyurethane had a weight average molecular weight of 21,700 and 95% of the acid groups were neutralized with potassium hydroxide.

Inventive Polyurethane PU-25: A polyurethane and polysiloxane polymer mixture was made by polymerizing, 41% isophorone diisocyanate, 24% 2,2-bis(hydroxymethyl)propionic acid (DMPA), 27% of a 2000 Mw polytetrahydrofuran polyol, and 8.1% siloxane functionalized diol having a molecular weight of 15,000 (SILAPLANE FM-DA26® Chisso America, Inc.), and then adding 2.3% of hydroxyl terminated polydimethyl siloxane containing 14 to 18 mole % of diphenylsiloxane linkage having a molecular weight of 900-1000 (PDS-1615® Gelest, Inc.) where the PDS-1615 was withheld from the polymerization reaction until all isocyanate was reacted (as determined by infrared spectroscopy) to ensure that it could not incorporate into the polymer chains. The final ratio of isocyanate to reactive hydroxyl groups (NCO/OH) was 0.95. The resulting polyurethane and polysiloxane polymer mixture had a weight average molecular weight of 25,100 and 95% of the acid groups of the polyurethane were neutralized with potassium hydroxide.

### Evaluation of Dispersion Stability

Aqueous polyurethanes made with high Mw PDMS segments tend to naturally form a dispersion of particles containing high PDMS content dispersed in soluble polymer with little or no PDMS content. These dispersion can become unstable on standing and separate into two or more phases with the high-PDMS phase rising to the top. To assess the dispersion stability, a freshly prepared sample of the polyurethane was placed in a glass vial and allowed to stand undisturbed for at least 4 weeks. If no phase separation occurred the stability was rated as excellent. If only a slight residue was observed on the glass, the stability was rated as very good. A small ring formed on the glass that readily redissolved with minimal agitation was rated as good, and the slight formation of a separate phase that readily redisperses with agitation was rated as fair. A significant phase separation that does not redisperse with modest agitation was rated as poor, and formation of two or more highly incompatible phases was rated as very poor.

TABLE I

| | | | | Ratio of | | |
|---|---|---|---|---|---|---|
| | | | | isocyanate | | |
| | Weight % | | Weight % | to reactive | | Polyurethane |
| | 15K Mw | Type of low | of low Mw | diol or | | Dispersion |
| | pendant | Mw PDMS | PDSM | amine | Molecular | Stability after |
| | PDMS | containing | containing | groups | weight | approximately |
| Polyurethane | diol | diol | diol | (NCO/OH) | Mw | 4 weeks |
| PU-1 | 0 | none | 0 | 0.94 | 18,000 | excellent |
| PU-2 | 10.4 | none | 0 | 0.95 | 17,600 | poor |
| PU-3 | 0 | FM-DA11 | 10.4 | 0.95 | 17,500 | excellent |
| PU-4 | 0 | FM-DA21 | 10.8 | 0.95 | 18,800 | fair |
| PU-5 | 10.4 | none | 0 | 0.925 | 14,100 | Very poor |
| PU-6 | 10.3 | none | 0 | 0.975 | 26,100 | Very good |
| PU-7 | 10.2 | none | 0 | 1.1 | 28,000 | fair |
| PU-8* | 10.3 | none | 0 | 0.975 | 16,300 | poor |
| PU-9** | 10.4 | none | 0 | 0.975 | 15,400 | poor |
| PU-10 | 8.1 | FM-DA11 | 2.4 | 0.975 | 27,600 | Very good |
| PU-11 | 8.2 | FM-DA11 | 2.4 | 0.93 | 17,000 | excellent |
| PU-12 | 8.2 | FM-DA11 | 2.4 | 0.90 | 14,000 | good |
| PU-13 | 10.4 | FM-DA11 | 2.1 | 0.95 | 21,600 | fair |
| PU-14 | 10.5 | FM-DA11 | 4.2 | 0.95 | 22,500 | good |
| PU-15** | 8.2 | FM-DA11 | 2.1 | 0.93 | 16,600 | fair |
| PU-16 | 8.2 | FMS-9922 | 2.4 | 0.95 | 24,500 | Very good |
| PU-17 | 8.1 | FM-DA21 | 2.2 | 0.95 | 19,100 | good |
| PU-18 | 8.2 | DMS-C15 | 2.4 | 0.95 | 16,800 | good |
| PU-19 | 8.2 | PDS-1615 | 2.3 | 0.95 | 22,200 | excellent |
| PU-20 | 8.2 | DMS-S21 | 2.4 | 0.95 | 19,500 | good |
| PU-21 | 8.1 | DMS-A15 | 2.1 | 0.95 | 22,800 | excellent |
| PU-22 | 8.1 | DMS-C21 | 2.2 | 0.95 | 18,200 | good |
| PU-23 | 8.12 | Fluorolink | 2.17 | 0.93 | 22,400 | Very good |
| | | E10H | | | | |
| PU-24 | 8.12 | Fluorolink | 2.23 | 0.93 | 21,700 | Very good |
| | | D10H | | | | |
| PU-25 | 8.1 | PDS- | 2.3 | 0.95*** | 25,100 | excellent |
| | | 1615*** | | | | |

*Reaction stopped at 75% normal completion time by methanol addition.
**2000 Mw polytetrahydrofuran diol replaced with 1000 Mw polytetrahydrofuran diol.
***The PDS-1615 was added after complete reaction of NCO as measured by infrared spectroscopy.

Preparation of Magenta pigment dispersion M-1: A dispersion of magenta pigment Clariant Ink Jet Magenta E01 with an acrylic copolymer made from 37 wt % benzyl methacrylate, 30 wt % n-octadecylmethacrylate, and 33 wt % methacrylic acid as the pigment dispersant. The pigment dispersion has a volume weighted median particle diameter of less than 50 nm. The dispersant having 90% of the acid groups neutralized with potassium hydroxide.

Magenta Ink for Polyurethane Evaluation: Into an approximately 250 ml high density polyethylene bottle with magnetic stirring, the following components were added in order: high purity water, 0.02 wt % of the biocide Kordek MLX, 2 wt % of glycerol, 7 wt % of 1-(2-hydroxyethyl)-2-pyrrolidinone, 6 wt % of 2-imidazolidone, 3 wt % of 1,2-hexanediol, 0.5 wt % of Surfynol 465 surfactant, 1 to 2 wt % of polyurethane (from an approximately 20 to 30 wt % aqueous solution), and 5% of the magenta pigment dispersion M-1. The resulting 240 g of ink were stirred for at least an hour and filtered with a 1.0 um disk filter.

### Durability Testing of Ink Sets Having Polyurethane Binders

Each magenta ink prepared with the various polyurethanes was loaded into an ink cartridge and installed in a drop-on-demand thermal print head along with cartridges of cyan, yellow, and black inks prepared from pigments dispersed in a similar method to the magenta pigment and prepared into inks with similar humectants, but the non-magenta inks comprised lower pigment concentrations (less than 4 weight % pigment), and a non-polysiloxane containing polyurethane similar to PU-1. A scratch test target was printed on an alumina and silica based glossy print media. The test target consisted of three separate 64-patch targets made up of various color patches. One target each was scratch tested at 10 minutes and 24 hours after print ejection using a 3 mm blunt tungsten carbide stylus with a 150 g load.

The overall scratch score was determined by examining each of the 64 image patches after scratching with the tungsten carbide stylus. If the scratch penetrated through the image such that the receiver was clearly visible the patch was scored with a 2. Scratches of this nature are easily visible and highly objectionable to a consumer. If the scratch was clearly visible under normal lighting conditions and does not require any tilting of the image to view the scratch the patch was scored a 1. If a deformation of the surface was evident only after tilting (but no visible scratch was seen) the image the patch was scored a zero. Thus, the maximum worst possible abrasion resistance would result in a score of 128 and the best possible abrasion resistance would result in a score of zero. The scratch test results for each ink-set at the two times after print ejection are tabulated below in Table 2.

### Latency Testing

The latency performance of the magenta inks is evaluated by printing a target consisting of 25 lines formed by firing all nozzles. Each set of 25 lines is printed after a delay where no nozzles are fired while the print head slews as if it were printing. The delays vary from 2 to 20 seconds in 2 second steps. Each set of 25 lines is analyzed with magnification to determine how many ejections or lines are required to return the print head to normal operation after a given delay. A perfect performing ink would produce a perfect steady state line on the first of the 25 lines regardless of the delay time. Actual inks often show some degradation in the first few lines printed after even a short delay and may not print any lines after a long delay time. The printed targets are judged and graded for each of the 10 delay times ranging from 2 seconds to 20 seconds. The first occurrence of a steady state line is the raw score. Each raw score is inverted and then multiplied by the associated delay time (the inverted raw score is weighted by the delay time). For example, when it takes 10 ejection attempts to print a steady-state quality line after the 8 second delay, the raw score would be 10, the inverted raw score would be 0.1, and the weighted score would be 0.8. Each of the weighted scores from the 10 different delay times are summed and then normalized by the score for a perfect ink (i.e., where all delay times would get a raw score of 1). This give a perfect performing ink a Latency Metric score of 1, and a very poor ink a low Latency Metric score near zero. Inks preferred for commercial use score at least 0.3 or higher. Inks with poor latency performance that might require significant print head maintenance typically score about 0.2 or less.

TABLE II

| | | Poly- | | | | |
|---|---|---|---|---|---|---|
| | | urethane | Poly- | 10 minute | 24 hour | |
| | Poly- | Dispersion | urethane | Durability | Durability | Latency |
| Ink | urethane | Stability | level | Score | Score | Metric |
| Comp-1 | PU-1 | excellent | 1 wt % | 89 (poor) | 70 (very | 0.36 (good) |
| | | | | | poor) | |
| Comp-2 | PU-1 | excellent | 2 wt % | 58 (fair) | 29 (good) | 0.12 (very |
| | | | | | | poor) |
| Comp-3 | PU-2 | poor | 1 wt % | 32 (good) | 22 (good) | 0.32 (good) |
| Comp-4 | PU-3 | excellent | 1 wt % | 79 (poor) | 64 (very | 0.36 (good) |
| | | | | | poor) | |
| Comp-5 | PU-4 | fair | 1 wt % | 49 (fair) | 49 (poor) | 0.39 (good) |
| Comp-6 | PU-5 | Very poor | 1 wt % | 31 (good) | 16 (very | 0.33 (good) |
| | | | | | good) | |
| Comp-7 | PU-6 | Very good | 1 wt % | 34 (good) | 21 (good) | 0.20 (poor) |
| Comp-8 | PU-7 | fair | 1 wt % | 23 (very | 13 (very | 0.10 (very |
| | | | | good) | good) | poor) |
| Comp-9 | PU-8 | poor | 1 wt % | 23 (very | 21 (good) | 0.31 (good) |
| | | | | good) | | |
| Comp-10 | PU-9 | poor | 1 wt % | 30 (good) | 20 (good) | 0.30 (good) |
| Inv-1 | PU-10 | Very good | 1 wt % | 32 (good) | 25 (good) | 0.33 (good) |
| Inv-2 | PU-11 | excellent | 1 wt % | 35 (good) | 22 (good) | 0.41 (good) |
| Inv-3 | PU-12 | good | 1 wt % | 32 (good) | 26 (good) | 0.50 (very |
| | | | | | | good) |
| Inv-4 | PU-13 | fair | 1 wt % | 33 (good) | 19 (good) | 0.39 (good) |
| Inv-5 | PU-14 | good | 1 wt % | 25 (good) | 21 (good) | 0.37 (good) |
| Inv-6 | PU-15 | fair | 1 wt % | 40 (good) | 23 (good) | 0.37 (good) |
| Inv-7 | PU-16 | Very good | 1 wt % | 30 (good) | 25 (good) | 0.29 (good) |
| Inv-8 | PU-17 | good | 1 wt % | 32 (good) | 23 (good) | 0.29 (good) |
| Inv-9 | PU-18 | good | 1 wt % | 33 (good) | 17 (good) | 0.28 (good) |
| Inv-10 | PU-19 | excellent | 1 wt % | 34 (good) | 27 (good) | 0.28 (good) |
| Inv-11 | PU-20 | good | 1 wt % | 36 (good) | 21 (good) | 0.35 (good) |
| Inv-12 | PU-21 | excellent | 1 wt % | 25 (good) | 12 (good) | 0.31 (good) |
| Inv-13 | PU-22 | good | 1 wt % | 22 (good) | 15 (good) | 0.36 (good) |
| Inv-14 | PU-23 | very good | 1 wt % | 9 (excellent) | 1 (excellent) | 0.26 (good) |
| Inv-15 | PU-24 | very good | 1 wt % | 22 (good) | 2 (excellent) | 0.31 (good) |
| Inv-16 | PU-25 | excellent | 1 wt % | 25 (good) | 4 (excellent) | 0.24 (fair) |

Tables I and II show that the polyurethanes prepared with only the relatively higher Mw pendant siloxane diol, while demonstrating good durability, show poor dispersion stability unless they are prepared at a high NCO/OH ratio that results in a higher molecular weight and relatively poor latency performance in the ink. Polyurethanes prepared with only relatively low Mw polysiloxane, on the other hand, demonstrated poor durability when employed at relatively low concentration based on the pigment concentration. The polyurethanes prepared with a blend of a relatively higher Mw PDMS diol and a lower fraction of relatively lower Mw PDMS diol show generally good (and at least fair) dispersion stability with good photo durability and jetting latency performance.

### Inks Containing Self-Dispersed Carbon Black Pigments

A series of black inkjet inks designed for text printing on plain papers was generated in order to evaluate the permanence of a printed image with respect to the resistance against smearing by a highlighter marker. Inks were formulated to contain 4% by weight of a self-dispersing pigment prepared by oxidation of NIPex-160 carbon black pigment. Each of the inks contained a humectant mixture of glycerol and triethylene glycol, 0.4% of an acrylic binder polymer, 0.37% of Surfynol 465 non-ionic surfactant and a biocide. The base ink formulation was then modified to contain additional components as outlined in Table III below.

Each of the inks were loaded into a text black ink cartridge for a Kodak All-in-One printer and a total of three density patches, having a rectangular area 1 cm×2 cm, were printed onto a sheet of Kodak Ultimate Paper using a Kodak ESP-3 inkjet printer. The resulting density patches prior to any highlighter smearing were measured for visual density using a Greytab Macbeth Spectrolino. An Eberhard Faber® 4008 Highlighter marker was swiped across each of the density patches one time and the marker was cleaned in between each patch to remove any pigment that was transferred during the smearing operation. A swipe of the highlighter marker was also made on an area of the Kodak Ultimate Paper that did not contain any printed pigment in order to establish the colorometric properties of a highlighter pass on an unprinted area. The highlighter smearing test was conducted 5 minutes after printing and 24 hours after printing.

A Greytab Macbeth Spectrolino was used to measure the L*, a* and b* values of a single pass of the highlighter marker in the unprinted area of the paper and in an area where the highlighter had traveled across each of the smeared density patches on the paper. The L*, a* and b* values were then used to calculate the CIE Delta E2000 value representing the difference in color between a pass of the highlighter in an unprinted area of the paper versus a swipe that had gone across a printed area of the paper. In this case, a high value of Delta E2000 indicates that more of the pigment from the original density patch was smeared by the action of the highlighter marker and would indicate poorer highlighter smear resistance. The results of the printing and highlighter smear tests are summarized in Table III.

TABLE III

| | | | Density | Delta | Delta |
|---|---|---|---|---|---|
| Ink | | | of | E2000 | E2000 |
| Identifi- | Additional | Descrip- | Printed | (5- | (24- |
| cation | Component | tion | Patch | minute) | hour) |
| Comp-1 | 1% | Nano- | 1.46 | 11.8 | 4.4 |
| | Michemlube | particle | | | |
| | 110 | wax | | | |
| Comp-2 | 1% LX-1576 | Nano | 1.48 | 9.4 | 2.7 |
| | | particle | | | |
| | | wax | | | |
| Comp-3 | 1% | Poly- | 1.44 | 8.3 | 3.0 |
| | Polyurethane 1 | carbonate | | | |
| Inventive-1 | 1% | PDMS | 1.45 | 5.2 | 1.5 |
| | Polyurethane 11 | | | | |
| Comp-4 | No additional | | 1.46 | 10.4 | 7.0 |
| | component | | | | |

Table III illustrates that each of the text black inks is capable of printing to densities in excess of 1.4 and are approximately equivalent in density before application of a highlighter marker to the printed area. The highlighter smear resistance, as evidenced by the low Delta E2000 numbers at 5-minutes and 24-hours after printing, is superior for the ink containing a PDMS-based polyurethane of the present invention.

1. A method for printing an inkjet image comprising:
I) providing an aqueous inkjet ink composition comprising:
(a) water,
(b) dispersed pigment particles,
(c) a humectant, and
(d) a polyurethane polymer additive comprising polyurethane polymer chains including at least first segments having a polysiloxane group of weight average molecular weight greater than about 10,000 daltons pendant to the polyurethane polymer chain backbone,
wherein (i) the polyurethane polymer additive further comprises polyurethane polymer chains including second segments having a polysiloxane group of weight average molecular weight less than about 6,000 daltons either pendant to the polyurethane polymer backbone or a part of the polyurethane polymer backbone or (ii) the composition further comprises a polysiloxane polymer additive of weight average molecular weight of less than about 6,000 daltons which is not pendant to a polyurethane polymer backbone or a part of a polyurethane polymer backbone, and
further wherein the polyurethane polymer additive has a weight average molecular weight of at least 10,000 daltons and a sufficient number of acid groups to provide an acid number greater than 20; and
II) jetting the inkjet ink in the form of ink drops onto a recording element to form a printed image.

2. The method of claim 1, wherein the inkjet ink composition is jetted with a thermal inkjet printhead.

3. The method of claim 2, wherein the first segments of the polyurethane polymer in the ink composition comprise pendant polysiloxane groups having a weight average molecular weight between 10,000 and 100,000 daltons present in the polyurethane polymer additive at between 1% and 30% by weight of the total polyurethane polymer, and wherein (i) the polyurethane polymer additive further comprises polyurethane polymer chains including second segments having a polysiloxane group of weight average molecular weight of from 500 to 6,000 daltons either pendant to the polyurethane polymer backbone or a part of the polyurethane polymer backbone present in the polyurethane polymer additive at between 1% and 30% by weight of the total polyurethane polymer or (ii) the composition further comprises a polysiloxane polymer additive of weight average molecular weight of from 500 to 6,000 daltons which is not pendant to a polyurethane polymer backbone or a part of a polyurethane polymer backbone present at from 1% to 30% by weight based on the combined weight of the polyurethane polymer additive and the polysiloxane polymer additive.

4. The method of claim 3, wherein the first segments comprise pendant polysiloxane groups having a weight average molecular weight between 10,000 and 50,000 daltons.

5. The method of claim 4, wherein the first and second segments are each present in the polyurethane polymer additive at greater than or equal to 1% by weight of the total polyurethane polymer, the first segments are present in the polyurethane polymer additive at a wt % greater than or equal to that of the second segments, and the total amount of the first and second segments in the polyurethane polymer additive is between 2% and 30% by weight of the total polyurethane polymer.

6. The method of claim 5, wherein the first segments are present in the polyurethane polymer additive at between 2% and 29% by weight of the total polyurethane polymer, and the second segments are present in the polyurethane polymer additive at between 1% and 15% by weight of the total polyurethane polymer.

7. The method of claim 5, wherein the first segments are present in the polyurethane polymer additive at between 6% and 15% by weight of the total polyurethane polymer, and the second segments are present in the polyurethane polymer additive at between 1% and 4% by weight of the total polyurethane polymer.

8. The method of claim 5, wherein the second segments have a polysiloxane group of weight average molecular weight of from about 500 to about 5,000 daltons.

9. The method of claim 2, wherein the polyurethane polymer additive has a weight average molecular weight of from 10,000 to 50,000 daltons.

10. The method of claim 9, wherein the polyurethane polymer additive has a weight average molecular weight of from 15,000 to 30,000 daltons.

11. The method of claim 2, wherein the polyurethane polymer additive comprises polyurethane polymer chains including second segments having a polysiloxane group of weight average molecular weight less than about 6,000 daltons pendant to the polyurethane polymer backbone.

12. The method of claim 2, wherein the polyurethane polymer additive comprises polyurethane polymer chains including second segments having a polysiloxane group of weight average molecular weight less than about 6,000 daltons as a part of the polyurethane polymer backbone.

13. The method of claim 2, wherein the ink composition comprises a polysiloxane polymer additive of weight average molecular weight of less than about 6,000 daltons which is not pendant to a polyurethane polymer backbone or a part of a polyurethane polymer backbone.

14. The method of claim 2, wherein the dispersed pigment particles are present at from about 1 to about 10 wt % of the ink composition, and the polyurethane polymer additive is present at from 10 to 100% by weight based on the weight of dispersed pigment particles.

15. The method of claim 2, wherein the dispersed pigment particles are present at from about 4 to about 10 wt % of the ink composition, and the polyurethane polymer additive is present at from 10 to 30% by weight based on the weight of dispersed pigment particles.

16. The method of claim 15, wherein the pigment particles are magenta pigment particles.

17. The method of claim 2, wherein the pigment particles are self dispersed without the need for a separate dispersant.

18. The method of claim 1, wherein the inkjet ink composition is jetted with a drop-on-demand thermal inkjet printhead.

19. An inkjet printing system, comprising an inkjet printer responsive to digital signals, and containing an ink composition comprising:
(a) water,
(b) dispersed pigment particles,
(c) a humectant, and
(d) a polyurethane polymer additive comprising polyurethane polymer chains including at least first segments having a polysiloxane group of weight average molecular weight greater than about 10,000 daltons pendant to the polyurethane polymer chain backbone,
wherein (i) the polyurethane polymer additive further comprises polyurethane polymer chains including second segments having a polysiloxane group of weight average molecular weight less than about 6,000 daltons either pendant to the polyurethane polymer backbone or a part of the polyurethane polymer backbone or (ii) the composition further comprises a polysiloxane polymer additive of weight average molecular weight of less than about 6,000 daltons which is not pendant to a polyurethane polymer backbone or a part of a polyurethane polymer backbone, and
further wherein the polyurethane polymer additive has a weight average molecular weight of at least 10,000 daltons and a sufficient number of acid groups to provide an acid number greater than 20.

20. The system of claim 19, wherein the inkjet printer comprises a thermal inkjet printhead.
